(19) United States
(12) Patent Application Publication
(10) Pub. No.: US 2022/0293003 A1
(43) Pub. Date: Sep. 15, 2022

(54) COMPUTER-ASSISTED ASSESSMENT SYSTEM

(71) Applicant: Center for Curriculum Redesign, Boston, MA (US)

(72) Inventors: Charles Fadel, Milton, MA (US); Emma Dillon Fortier, Philadelphia, PA (US); Claude Anthony Cruz, Troutdale, OR (US)

(21) Appl. No.: 17/690,435

(22) Filed: Mar. 9, 2022

Related U.S. Application Data
(60) Provisional application No. 63/158,432, filed on Mar. 9, 2021.

(51) Int. Cl. G09B 19/00

(52) U.S. Cl. CPC G09B 19/00

(57) ABSTRACT

A computer-implemented system and method gathers data about a student's activities and uses that data to assess the student's abilities relative to a plurality of competencies, each of which has a plurality of sub-competencies. An overall assessment score for the student may be generated based on the assessments of the student's abilities relative to the plurality of competencies. This assessment score may be updated over time to reflect the student's development and guide their teacher.

### CROSS-REFERENCE TO RELATED APPLICATIONS

This application claims the benefit of, and hereby incorporates by reference, U.S. Prov. Pat. App. No. 63/158,432, filed on Mar. 9, 2021, entitled, “Polyhedric-Angulation System of Assessments.”

### BACKGROUND

Existing tools for assessing students have a variety of drawbacks. For example, they tend to assess students only at a small number of discrete points in time (e.g., at the end of each semester) and to assign too much weight to each such assessment. The resulting assessments fail to capture students' actual knowledge, skills, character and meta-learning abilities, not only at any particular time, but also over the students' educational careers and beyond into the workforce. The present situation also complicates life for the teachers, who are unable to guide students' learning.

### SUMMARY

A computer-implemented system and method n-angulates a student's level of performance by combining a plurality of evaluations of the student performed using different assessment methods. One such method gathers data about a student's digital activities and uses that data to assess the student's abilities relative to a plurality of competencies, each of which has a plurality of sub-competencies. A digital assessment score for the student may be generated based on the assessments of the student's abilities relative to the plurality of competencies. An overall assessment of the student may be generated based on the student's digital assessment score and the other evaluations of the student. The student's overall assessment may be updated over time.

Other features and advantages of various aspects and embodiments of the present invention will become apparent from the following description and from the claims.

### BRIEF DESCRIPTION OF THE DRAWINGS

FIG. 1 is an illustration of a Learner's Profile of an individual according to one embodiment of the present invention.

FIG. 2 is an illustration of a sub-competency matrix for the Collaboration competency according to one embodiment of the present invention.

FIGS. 3A-3B illustrate a table representing an overview of how a student would engage in a plurality of digital activities to demonstrate a plurality of sub-competencies within a particular competency according to embodiment of the present invention.

FIGS. 4A and 4B are examples of curves that may be applied to progression levels of a student according to one embodiment of the present invention.

FIG. 4C is a graph showing the application of statistical techniques, including but not limited to ARIMA (auto-regressive integrated moving average) to student output in order to ensure that a student is not overly punished for any singular or extreme success or failure according to one embodiment of the present invention.

FIG. 5 illustrates examples of digital inputs for measuring how a student's engagement in a particular digital activity may demonstrate the student's ability to engage in particular sub-competencies according to embodiment of the present invention.

FIG. 6 illustrates how the digital inputs of FIG. 5 may be weighted and further quantified according to embodiment of the present invention.

FIG. 7 is a table which represents how a score may be produced for a student relative to a particular digital activity according to embodiment of the present invention.

FIG. 8 is an example of a report card that may be generated for a plurality of students according to embodiment of the present invention.

FIG. 9 is an illustration of an assessment management system according to one embodiment of the present invention.

FIG. 10 illustrates a variety of data sources that may be used as inputs to a student's assessments according to one embodiment of the present invention.

FIG. 11 is a graph illustrating proficiency of a student in collaboration over time according to one embodiment of the present invention.

FIG. 12 is a dataflow diagram of a system for generating an integrated assessment of a student over time according to one embodiment of the present invention.

FIG. 13 is a flowchart of a method performed by the system of FIG. 12 according to one embodiment of the present invention.

FIG. 14 illustrates a set of weights associated with two different students according to one embodiment of the present invention.

FIG. 15 illustrates calculation of a weighted competency score for a student according to one embodiment of the present invention.

### DETAILED DESCRIPTION

Measuring skills such as critical thinking and creativity, character qualities such as mindfulness and curiosity, and meta-learning abilities such as metacognition is pseudo-scientific using traditional psychometric tests, at least because ascertaining one's level of performance is both time-dependent and context-dependent, and because these complex competencies are not measurable in single-shot tests.

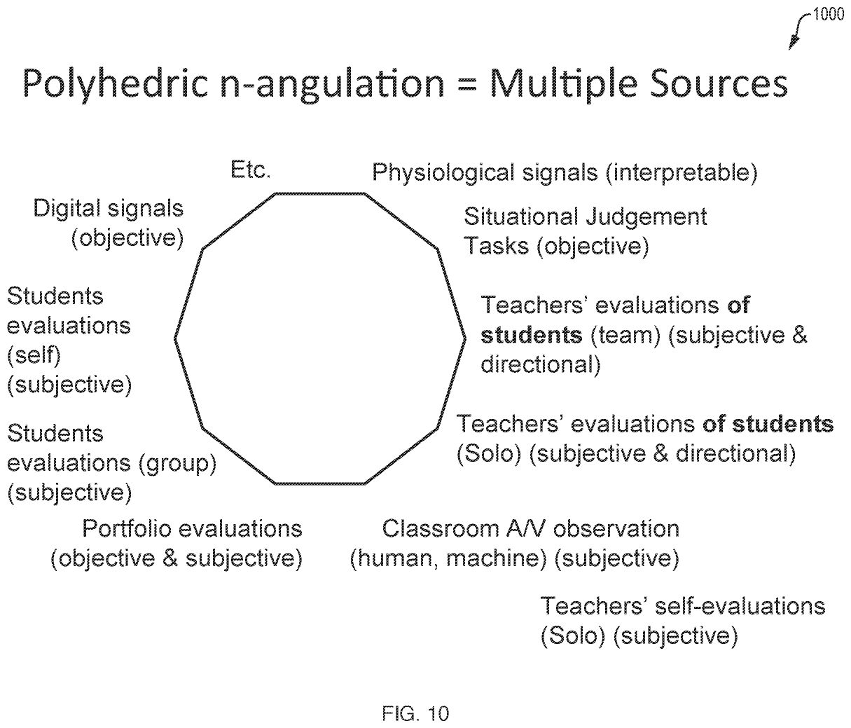

Embodiments of the present invention address this problem using computer-implemented methods and systems which implement a model to “n-angulate” one's level of performance by combining several different assessment methods (also referred to herein as “sources”), as illustrated in FIG. 10. Although the example in FIG. 10 incorporates twelve assessment methods (i.e., digital signals, situational judgment tests, student evaluations (self and group), student portfolio evaluations (objective and subjective), classroom audiovisual observation (manual and automatic), teacher self-evaluations, physiological signals of students, and teacher evaluations of students (solo and team)), this particular number is merely an example and does not constitute a limitation of the present invention. Instead, embodiments of the present invention may apply the techniques disclosed herein to any number of assessment methods (e.g., greater than or less than four) of any type, in any combination.

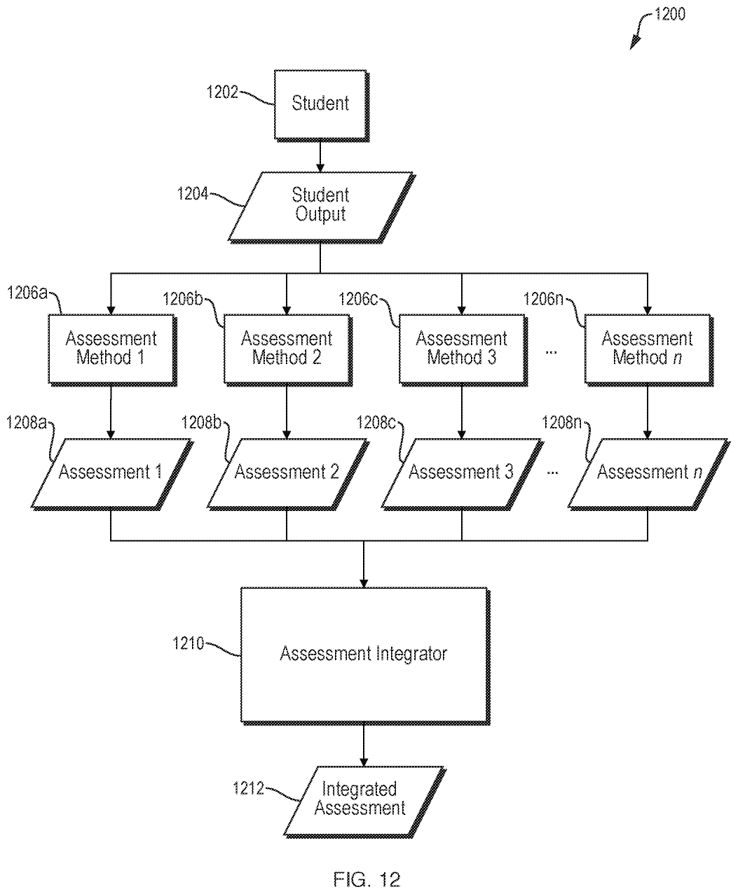

For example, more generally, FIG. 12 illustrates a system 1200 which includes a student 1202. Although terms such as “student” and “learner” are used interchangeably herein, such terms should be understood to refer to any person who may be assessed using embodiments of the present invention, and are not limited to a person currently or formerly enrolled in a school or university. For example, the term “student,” as used herein, may refer to an employee whose job performance is assessed. Furthermore, because embodiments of the present invention may be used to assess a person over time, terms such as “student” may refer herein to a person who is a student (e.g., a K-12 student) during one period of time during which the person is assessed by the system 1200, and who is no longer a student (e.g., because the person has left school and become an employee) during another period of time during which the person is assessed by the system 1200.

The student 1202 produces output 1204. As will become clear from the description herein, the student output 1204 may include any of a variety of types of output, and may include output produced in a wide variety of ways, in a wide variety of places, over a wide range of times. The student output 1204 may include, for example, any one or more of the following, in any combination, and without limitation:
content that is created, modified, and/or read by the student, such as content including any combination of text content, audio content (e.g., speech of the student 1202), and video content;
physical movement of the student 1202, which may be captured using any kind(s) of sensors, such as image sensors (e.g., cameras), motion sensors, or haptic sensors, which may generate corresponding sensor output, which may be stored in any suitable digital form, such as in the form of still images and/or videos;
signals representing values of physiological parameters of the student, such as heartrate, blood pressure, temperature, respiration rate, carbon dioxide, and oxygen saturation, which may be generated using appropriate sensors by performing sensing operations on the student;
actions performed by the student 1202 in connection with content and/or physical objects, such as actions of creating, editing, reading, or deleting content; and
behaviors demonstrated by the student visibly to the teacher/instructor.

Some or all of the student output 1204 may be in digital form and be stored in one or more non-transitory computer-readable media. Some of the student output 1204 may, however, be stored in analog form, such as in the form of text written on paper. Embodiments of the present invention may, however, digitize such analog output to create digitized versions of that output within the student output 1204, such as by using any of the types of sensors disclosed herein (e.g., cameras, microphones, and/or physiological sensors) to sense matter and/or energy and generate corresponding digital representations of that matter and/or energy, and to store such digital representations in suitable formats.

The student 1202 may intentionally provide some or all of the output 1204 to the system 1200 intentionally, such as by typing or otherwise entering such output 1204 into one or more computing devices using any suitable input device(s) (e.g., keyboards, mice, touchpads, touchscreen, microphones, or cameras). As this implies, the student output 1204 may include input that the student 1202 provides to one or more computing devices, which is also “output” in the sense that it is output by the student. Any such output that is intentionally provided by the student 1202 to one or more digital devices is an example of the term “digital activity,” as that term is used herein. For example, editing a document is an example of “digital activity” as that term is used herein.

Some or all of the student output 1204 may, however, be captured and generated by the system 1200 automatically, with or without the student 1202 intentionally providing such output 1204. For example, the student 1202 may participate in a class by speaking answers in response to a teacher's questions. One or more cameras and microphones located in the classroom may automatically capture the student 1202's speech and automatically record such speech within the student output 1204 in digital form, without requiring any input from the student 1202 indicating that such speech is to be captured or recorded. This is merely one example of a way in which the system 1200 may generate the output 1204 as a side-effect of the student 1202's existing engagement in the learning experience.

The student output 1204 may include, for example, any of a variety of output 1204 received from the student during learning experiences in a school or other setting. For example, the student output 1204 may include test answers received from the student, essays or other text written by the student, homework assignments received from the student, and creative projects received from the student (e.g., poems, visual artwork, speeches (in textual, audio, or audiovisual form), dramatic performances, musical compositions, and musical performances).

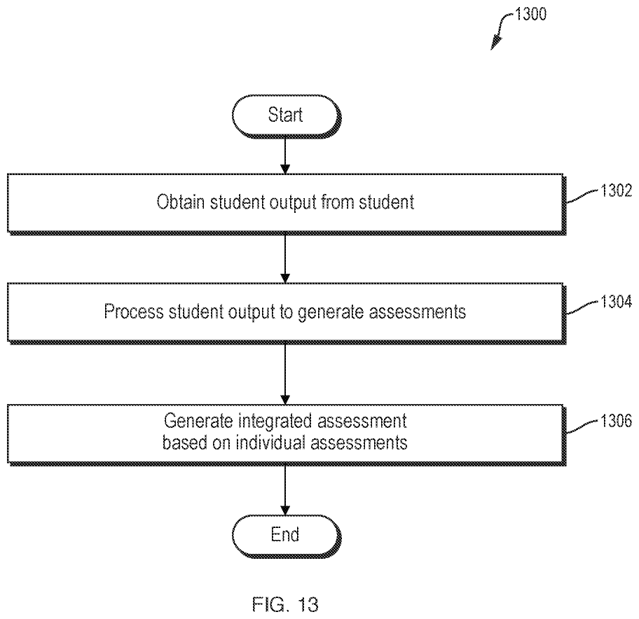

The system 1200 may include a plurality of assessment methods 1206a-n, which may receive the student output 1204 (FIG. 13, operation 1302) and process the student output 1204 to produce a plurality of corresponding assessments 1208a-n of the student 1202 (FIG. 13, operation 1304). Although four assessment methods 1206a-n and corresponding assessments 1208a-n are shown in FIG. 12 for ease of illustration, the system 1200 may include any number of assessment methods (i.e., n may be any number). Because the student output 1204 is received as input by the assessment methods 1206a-n, the student output 1204 may be referred to as “input” herein without loss of generality.

For example, some or all of the assessment methods shown in FIG. 10 may be used as some or all of the assessment methods 1206a-n in FIG. 12. As this implies, each of the assessment methods shown in FIG. 10 may receive some or all of the student output 1204 as input, process such input, and generate corresponding output in the form of one of the corresponding assessments 1208a-n.

Each of the assessment methods 1206a-n may operate on some or all of the student output 1204. Different ones of the assessment methods 1206a-n may operate on different subsets of the student output 1204. Those subsets may overlap or be disjoint from each other in any combination.

Different assessment methods 1206a-n may process the student output 1204 differently from each other. In other words, different assessment methods 1206a-n may use different methods to generate their corresponding assessments 1208a-n, respectively. As a result, the resulting assessments 1208a-n may differ from each other, even if they are generated based on the same student output 1204. For example, assessment method 1206a may operate on a particular subset of the student output 1204 to produce assessment 1208a. Assessment method 1206b may operate on the same subset of the student output 1204 to produce assessment 1208b, which may differ from assessment 1208a.

As described elsewhere herein, additional output may be added to the student output 1204 over time. For example, as the student 1202 takes additional tests, the student 1202's test results may be added to the student output 1204. Similarly, contents of the student output 1204 may change over time. For example, the student output 1204 may include values of parameters associated with the student 1202, such as the student's grade point average (GPA). Such parameter values may change within the student output 1204 over time. Any of the assessment methods 1206a-n may be applied to some or all of the student output 1204 at a first time (which may be a first point in time or a first time period) to produce corresponding assessments 1208a-n which correspond to the first time. If the student output 1204 changes in some way at a second, later time (e.g., by additional output being added to the student output 1204 and/or by existing data changing within the student output 1204), some or all of the assessment methods 1206a-n may be applied to some or all of the changed student output 1204, including the new and/or changed data within the student output 1204, to produce additional and/or modified assessments 1208a-n which correspond to the second time (which may be a second point in time or a second time period).

For example, consider the student output 1204 as it exists at a particular point in time, e.g., upon completion of the 6^{th} grade by the student 1202. The assessment method 1206a may be applied to some or all of the student output 1204 at that time to produce a corresponding assessment 1208a of the student at that time. Then assume that the student output 1204 has changed, such as at the end of the student 1202's completion of the 7^{th} grade, in which case the student output 1204 may include, for example, contents and results of tests taken by the student 1202 during the 7^{th} grade. The assessment method 1206a may be applied to some or all of the student output 1204 as it exists at that time, such as by applying the assessment method 1206a to the entirety of the student output 1204 (which includes both the student output 1204 that existed upon completion of the 6^{th} grade by the student and the additional student output 1204 that was added during the student 1202's completion of the 7^{th} grade) or to any subset of the student output 1204 (e.g., only the subset of the student output 1204 that was added during the student 1202's completion of the 7^{th} grade), to produce a new student assessment 1208a or a modified version of the assessment 1208a. Such a process may be repeated any number of times in connection with any modifications to the student output 1204 over time.

As just some examples of situations in which the system 1200 may generate the assessments 1208a-n at multiple times, such assessments 1208a-n may be generated for each of a plurality of courses, a plurality of projects, a plurality of disciplines, a plurality of competencies (i.e., skills, character, and meta-learning), a plurality of grades/years, and a plurality of weights.

The system 1200 may add any of the student 1202's assessments 1208a-n and/or 1212 to the student 1202's output 1204. As a result, any function disclosed herein as being performed on the student output 1204 should be understood to be applicable to the student 1202's assessments 1206a-n and/or 1208.

The system 1200 may store, in association with any unit of data within the student output 1204 (e.g., any parameter values, individual assessments 1208a-n, and/or integrated assessment 1212), either of both of: (1) a timestamp representing a time associated with that unit of data; and (2) a location stamp representing a location associated with that unit of data. Such a timestamp may represent any of a variety of information, such any one or more of the following, in any combination: (1) date; (2) time of day; (3) school year; (4) school semester; (5) school period; and (6) school class. Such a location stamp may represent any of a variety of information, such as any one or more of the following, in any combination: (1) geocoordinates (e.g., GPS coordinates or combination of latitude and longitude); (2) country identifier (e.g., name); (3) city identifier (e.g., name); (4) state identifier (e.g., name); (5) postal code; (6) identifier of a school or other institution; (7) identifier of a school district or other school region; and (8) identifier of a class or classroom.

The timestamp and location stamp associated with any unit of data within the student output 1204 may represent, for example, a time and location at which the student 1202 performed the activity represented by that unit of data, and/or the time and location at which the unit of data was generated, stored, and/or modified.

Some or all of the assessment methods 1206a-n may generate the corresponding assessments 1208a-n using processes that are partially or entirely automated, such as by using one or more computing devices of any kind. For example, the assessment method 1206a may produce the assessment 1208a based on some or all of the student output 1204 automatically, i.e., without receiving or relying on human input. Examples of such automated assessments include any one or more of the following in any combination: performing automated calculations on the student output 1204, performing automatic speech recognition on the student output 1204, performing natural language processing on the student output 1204, performing image recognition on the student output 1204, and applying models trained using machine learning (e.g., automated neural networks) on the student output 1204. As these examples imply, some or all of the assessment methods 1206a-n may be objective and not subjective, i.e., they may not rely on or use subjective human judgment. An assessment method 1206a-n may always use automated processes to generate its assessments, or may sometimes use automated processes to generate its assessments and other times use semi-automated or manual processes to generate its assessments. Some of the assessment methods 1206a-n may use automated processes to generate their assessments, while other ones of the assessment methods 1206a-n may use semi-automated or manual processes to generate their assessments.

The system 1200 also includes an assessment integrator 1210, which receives some or all of the assessments 1208a-n and generates, based on the received assessments 1208a-n, an integrated assessment 1212 (FIG. 13, operation 1306). Because the assessments 1208a-n may be received as inputs by the assessment integrator 1210, the assessments 1208a-n may also be referred to herein as “sources.” As the assessments 1208a-n change and/or grow over time (such as in any of the ways disclosed herein), the assessment integrator 1210 may generate, based on such modified and/or new assessments 1208a-n, a new and/or modified integrated assessment 1212. For example, the assessment integrator 1210 may generate, at a first time, based on some or all of the existing assessments 1208a-n, a first version of the integrated assessment 1212. Then assume that, at a second time, the assessments 1208a-n differ in some way from the first time, e.g., as the result of being generated based on updated student output 1204. In this case, the assessment integrator 1210 may update the integrated assessment 1212 based on those different assessments 1208a-n, or otherwise generate a second version of the integrated assessment 1212 based on those new assessments 1212. The second version of the integrated assessment 1212 may differ from the first version of the integrated assessment 1212 in any of a variety of ways. The assessment integrator 1210 may repeat this process any number of times over any period of time.

As described herein, the student output 1204, assessments 1208a-n, and the integrated assessment 1212 may change over time. Alternatively, or additionally, new versions of the student output 1204, the assessments 1208a-n, and the integrated assessment may be generated over time. Any such modifications or new versions may replace their previous versions or supplement their previous versions. The system 1200 may, for example, store a record of each modified and/or new version of the student output 1204, the assessments 1208a-n, and/or the integrated assessment 1212. As a result, the system 1200 may include a record (e.g., log) of any changes to and/or new versions of the student output 1204, the assessment method 1206a-n, and/or the integrated assessment 1212. Such records may, for example, be tagged with metadata, such as the time, location, and identity of the student 1202 associated with each such record. As described above, any such data may be stored within the student output 1204 itself.

The system 1200 may generate the assessments 1208a-n and/or the integrated assessment 1212 in an algorithmically understandable way, which allows peering into the system 1200 (e.g., into the student output 1204, the assessment methods 1206a-n, the assessments 1208a-n, the assessment integrator 1210, and/or the integrated assessment 1212), which advantageously gains the trust of teachers, administrators and policymakers. (This does not, however, preclude some of the background analytics, used by the assessment methods 1206a-n and/or the assessment integrator 1210) from using more opaque machine-learning algorithms.) Displaying the data by the assessment methods 1206a-n may take into account the sensitivities and needs of students, teachers, parents, and administrators.

Referring to FIG. 10, an example of a model including a set of assessment methods 1000, which may be used to generate a corresponding set of assessments, is shown. The assessment methods in the model 1000 of FIG. 10 are examples of the assessment methods 1206a-n in FIG. 12. It should be understood that each of the assessment methods 1000 shown in FIG. 10 generates a corresponding assessment. For example, the “physiological signals” assessment method shown in FIG. 10 generates, based on some or all of the student output 1204, a set of physiological signals, which are an example of an assessment. In particular, the model 1000 shown in FIG. 10 incorporates outputs of twelve types of assessments of a student or other individual, such as the following:
One or more assessments resulting from digital signals (embodiments of which are described in more detail below).
One or more assessments resulting from situational judgment tests. (Information about situational judgment tests may be found, for example, at https://en.wikipedia.org/wiki/Situational_judgement_test.)
One or more assessments based on an evaluation of the student (e.g., by the student and/or by a group of students).
One or more assessments of the student by one or more teachers (such as an individual teacher's assessment of the student or a team of teachers' assessment of the student).

As the example of FIG. 10 illustrates, the assessment methods 1000 may incorporate one or more objective assessment methods (e.g., digital signals, situational judgment tests) and one or more subjective assessment methods (e.g., self-evaluations, group evaluations), in any combination.

When combining the results of different assessment methods 1206a-n, embodiments of the present invention may assign weights to each of the assessment methods 1206a-n and corresponding assessments 1208a-n. Such weights may be the same as or different from each other, in any combination. For example, the system 1200 may:
assign lower weights to assessments generated using subjective assessment methods than to assessments generated using objective assessment methods;
assign a higher weight to a teacher's subjective assessment of the student than to the student's subjective assessment of himself/herself;
assign a higher weight to student output 1204 associated with the humanities than to student output 1204 associated with Science, Technology, Engineering & Math (STEM) disciplines, or vice versa (which is merely an example of how the system 1200 may assign different weights to student output 1204 associated with different disciplines);
assign a higher weight to student output 1204 associated with projects than to student output 1204 associated with didactic learning;
assign a higher weight to certain competencies (e.g., competencies labeled as critical in a particular discipline, such as the competency of critical thinking in math) than to other competencies;
assign a higher weight to student output 1204 associated with certain years/grades than to student output 1204 associated with other years/grades (such as by weighing student output 1204 associated with lower grades lower than student output 1204 associated with higher grades).

As a particular example, embodiments of the present invention may assign a weight of 30% to digital signals, a weight of 20% to SJTs, a weight of 25% to student self-evaluations, no weight (i.e., a weight of zero) to student group evaluations, a weight of 10% to teacher solo evaluations, and a weight of 15% to teacher group evaluations. Such a set of weights may be assigned to a particular project, for example. Different sets of weights may be assigned to different projects.

As another example, a set of weights may be assigned to a particular discipline (e.g., math) over a particular period of time (e.g., one semester). For example, a weight of 20% may be assigned to digital signals, a weight of 30% to SJTs, no weight (i.e., a weight of zero) to student self-evaluations, no weight (i.e., a weight of zero) to student group evaluations, a weight of 50% to teacher solo evaluations, and no weight (i.e., a weight of zero) to teacher group evaluations for the discipline of math during one semester. Different sets of weights may be assigned to the same discipline in different time periods, and to other disciplines in corresponding time periods.

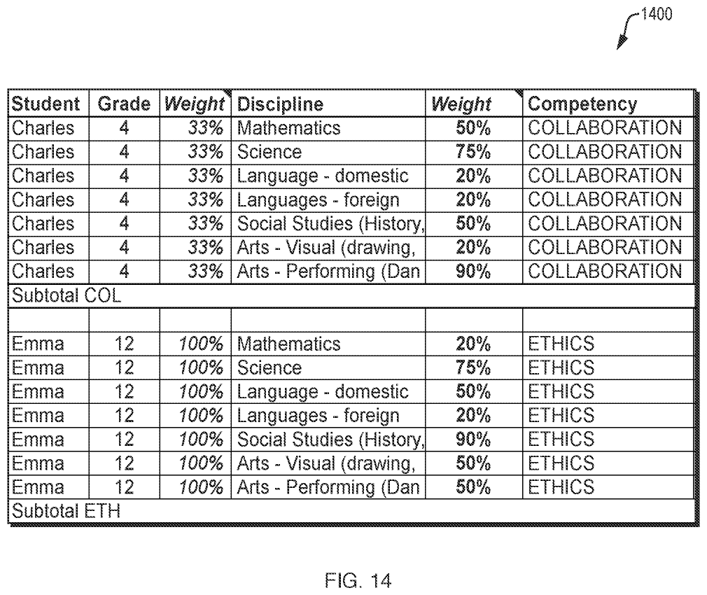

One example of a set of weights associated with two different students is shown in the table 1400 of FIG. 14. In this particular example, for the first student, the third column indicates that a weight of 33% is assigned to grade 4, whereas for the second student, a weight of 100% is assigned to grade 12. This difference between the relatively low weight assigned to grade 4 and the relatively high weight assigned to grade 12 is an example of weighting higher (e.g., more recent) grades more heavily than lower (e.g., more distant) grades in the student's career. This is merely one way in which the past performance of the student may be taken into account. Another non-limiting example would be to use ARIMA. Although in FIG. 14, the differing weights are shown as being applied to different students, those same weights could also (or instead) be applied to different grades of the same student.

Furthermore, in the example of FIG. 14, the fifth column indicates that various weights (some of which differ from each other) are assigned to various disciplines in connection with a particular competency (e.g., the competency of Collaboration in the case of Charles and the competency of Ethics in the case of Emma), in order to reflect that different disciplines contribute in different amounts to that competency.

As described above, some of the data that is collected about the student 1202 may be subjective. However, even subjective data may be quantified to be used by embodiments of the present invention, such as by using Likert scaling, sentiment analysis, Natural Language Processing (NLP), and/or other techniques.

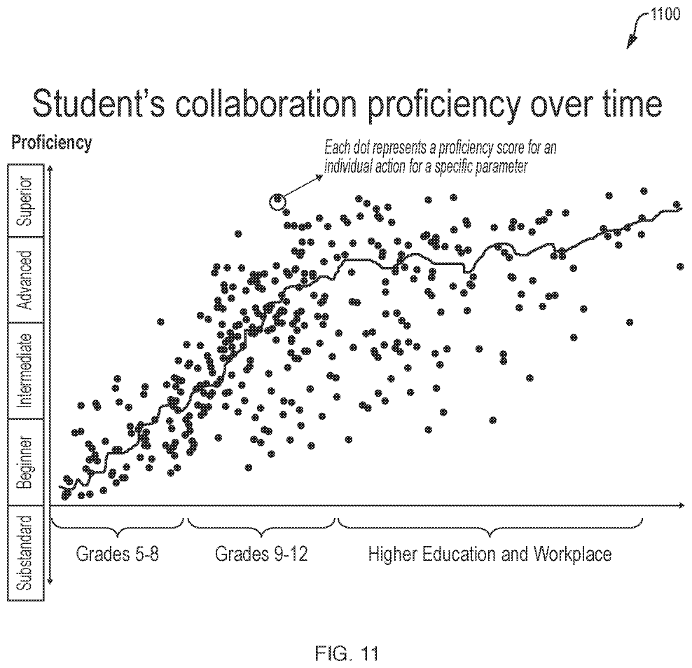

The multiplicity of data points used by embodiments of the present invention (e.g., within the student output 1204), and the multiplicity of the sources of such data points, allows the model to be very robust to noise in the measurements, and to be very protected against any single point of failure. Embodiments of the present invention may interpolate the student 1202's performance in a given competency, and may track the student 1202's progress over time, as shown, for example, in FIG. 11, which is a graph illustrating the progress of a student over many years.

Embodiments of the present invention may extract correlative analytics from the student output 1204, assessments 1208a-n, and integrated assessment 1212, such as by comparing the validity of the various dimensions. This allows the system 1200 to be manually or auto-adjusted over time, to reflect specific student's needs.

Such analytics may be used, for example, to determine whether the student's self-evaluation is correlated with the other data sources, and whether there is a bias in an individual teacher's ratings. Embodiments of the present invention may determine, based on the analytics, the source of variations in the student 1202's assessments over time in one or more disciplines. For example, embodiments of the present invention may determine whether the student 1202's teacher is responsible for such variations, or whether changes in the student 1202's skills over time are responsible for such assessments.

Embodiments of the present invention may be used to identify how each of the student 1202's competencies develop over time, and to identify relative rates of development of the student 1202's competencies during different time periods. For example, embodiments of the present invention may, based on the student 1202's output and/or one or more of the student's assessments 1208a-n and/or 121, determine that, during a first period of time, a first one of the student 1202's competencies (e.g., curiosity) grows more quickly than a second one of the student 1202's competencies (e.g., courage), and determine that, during a second period of time that is later than the first period of time, the second one of the student 1202's competencies grows more quickly than the first one of the student 1202's competencies.

Furthermore, embodiments of the present invention may be used to identify how a plurality of students' competencies develop over time in the aggregate. As described elsewhere herein, any of the techniques described herein in connection with the student 1202 may be applied by embodiments of the present invention to a plurality of students (which may include any number of students, such 100 or more, 1,000 or more, 100,000 or more, or even 1,000,000 or more students). As a result, embodiments of the present invention may generate the student data 1204 for each of a plurality of students (referred to herein as “student population data”). Embodiments of the present invention may apply any of a variety of techniques to evaluate the student population data and generate statistics based the student population data and to identify patterns and/or trends in the student population data over time. Such patterns and/or trends may cut across some or all of the students represented in the student population data. As just one example, embodiments of the present invention may determine, based on the student population data, that students typically (e.g., in the majority of students in the population) do not reach proficiency level 4 in the competency of Courage until they first reach proficiency level 3 in the competency of curiosity. This is merely one example—in this case, developmental timing—of a trend or pattern that embodies the present invention may identify automatically based on the student population data.

Once an embodiment of the present invention has identified such a trend or pattern, it may compare that trend or pattern to other student population data, such as a set of student population data that is distinct from the student population data that was used to identify the trend or pattern, or a subsequent version of the student population data that was used to identify the trend or pattern (i.e., after additional, newer, data has been added to the student population data). Embodiments of the present invention may then determine, based on the comparison, whether the trend or pattern applies to the other student population data. The identified trend or pattern may be seen as a hypothesis, which embodiments of the present invention may test in this way against additional data.

As a generalization, it is the correlative function of any angle(s) with any other angle(s), from which can be extracted, for example:
Causalities: is it the Teacher's issues, or the student? The discipline's issues or the Competency?
Simplifications: strength is several competencies may indicate a weakness or strength in others, thereby allowing to simplify the models.
Predictions: Is a given student on the right track, when we extrapolate?

The system may embed an initial, “manual” hypothesis, in the form of initial weights assigned to disciplines in connection with corresponding competencies (see columns 5 and 6 in the table of FIG. 14) which can then be calibrated by auto-normalizing over time.

Furthermore, embodiments of the present invention allow users to use any set of weights they wish (local control), while the system 1200 may generate and store a “clean” comparison by auto-adjusting the various local weights to a normed valuation of its database. More generally, the system 1200 may enable different sets of weights to be used by different users of the system 1200, thereby resulting in different assessments 1208a-n and 1212, where each set of assessments corresponds to a distinct set of weights.

The system 1200 may choose to ignore some data points (e.g., corresponding to a time period during which the student 1202 was sick) and provide the service anyway, without necessarily tabulating the data in its master database. It can also modify its own norm over time based on the multiplicity of inputs.

Embodiments of the present invention allow for many ways in which algorithmic analysis—both human and automated—of the data (refinement of the measurements, principal component analysis, etc.) may be performed, but also to recommend pre-emptive interventions since this is a formative assessment mindset.

Furthermore, by applying methods such as ARIMA (auto-regressive integrated moving average) to the overall data, embodiments of the present invention may ensure that a student is not overly punished for any singular or extreme success or failure (due to a life event, specific classroom circumstances, etc.). The depth of the ARIMA may be variable, and it may be either constant or extend through life up to a certain number of years. ARIMA is only one example of such methods.

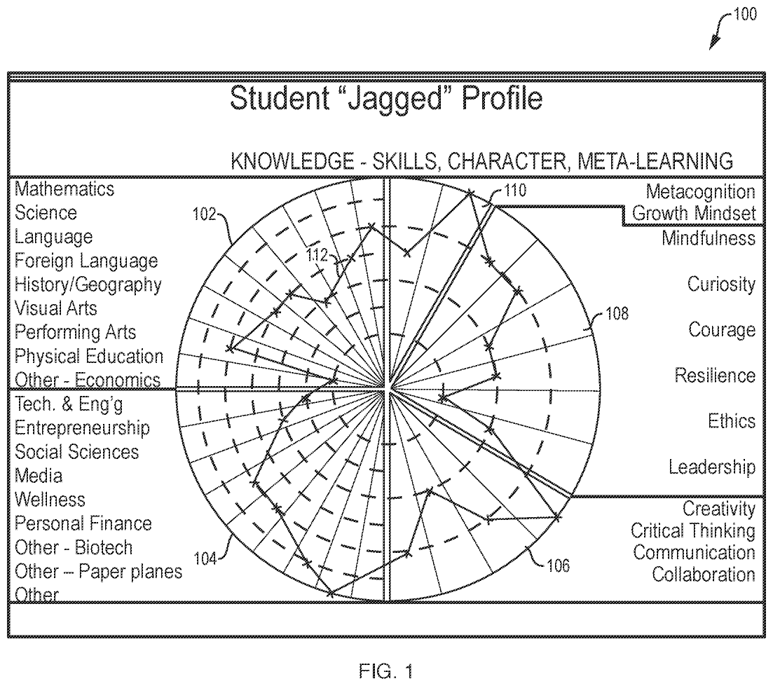

Embodiments of the present invention include computer-implemented methods and systems for creating a “jagged profile” of an individual (e.g., student), and for updating that jagged profile to change and shift throughout the individual's life, including, for example, their years in school and their subsequent work as a professional. A graphical representation of such a jagged profile 100 is illustrated in FIG. 1. The particular features of the jagged profile 100 shown in FIG. 1 are merely illustrative, user-interface examples and do not constitute limitations of the present invention.

As shown in FIG. 1, the jagged profile 100 includes several sections for purposes of example, namely a first section 102 (including disciplines such as mathematics, science, and language); a second section 104 (including disciplines such as technology and engineering, entrepreneurship, and social sciences); a third section 106 (including skills such as creativity, critical thinking, communication, and collaboration); a fourth section 108 (including character, such as mindfulness, curiosity, and courage, resilience, ethics, and leadership); and a fifth section 110 (including meta-learning competencies of metacognition and growth mindset). The particular sections, and corresponding disciplines and competencies, shown in FIG. 1 are merely examples and do not constitute limitations of the present invention.

A particular individual's measurements 112 within the profile 100 are represented by a plurality of points within the profile (connected by line segments), where each point represents a measurement of the individual with respect to a corresponding one of the competencies in the profile. For example, the measurements 112 include one point representing the individual's measurement for the discipline of mathematics, one point representing the individual's measurement for the competency of mindfulness, and so on.

Traditional education typically covers the left half of the profile 100 (e.g., sections 102 and 104, which are collectively referred to herein as “knowledge” or “disciplines”), but has historically (and presently) struggled with effectively assessing and measuring the right half—namely the competencies (skills, character, and meta-learning) of an individual (e.g., sections 104, 106, and 108). In contrast, embodiments of the present invention include techniques for measuring an individual in relation to all of the subjects in the profile 100 (e.g., the disciplines of sections 102 and 104, and the competencies of sections 106, 108, and 110).

Embodiments of the present invention may repeat such measurements over time, such as multiple times in one day, on multiple days, in multiple weeks, multiple semesters, and even multiple years. In this way, the measurements 112 within the jagged profile 100 may change over time throughout a student's life, such as from their years in school to their work as a professional.

More generally, embodiments of the present invention may generate a digital signal representing an assessment of a student. For example, one of the assessment methods 1206a-n (FIG. 12) may be a method that generates such a digital signal of the student 1202 based on some or all of the student output 1204. For example, assume that the assessment method 1206a generates such a digital signal. In such an example, the assessment 1208a is a digital signal representing an assessment of the student 1202. Such a digital signal, and hence the assessment 1208a, may take the form of a jagged profile 100 of the kind shown in FIG. 1.

As will be described in more detail herein, an individual's digital signal, as generated by embodiments of the present invention (such as may be represented by the individual's jagged profile 100), represents a formative assessment of the individual that is more resilient to single-point of failure than existing methods of (summative) assessment, which are heavily psychometrics-laden. By collecting a vast (perhaps astronomic) amount of data points relating to an individual over time, such as over the course of the individual's educational and professional career, such a digital signal may be created that depicts an accurate and full image of a student's competencies, in this case collaborative abilities as an example. In contrast, because existing assessment methods are so “high-stakes,” many of them attempt to be absolutely perfect and lead to worries about students gaming the system or about controlling the context. Embodiments of the present invention largely circumvent these problems with existing assessment techniques. For example, if an embodiment of the present invention collects data about a student from the 5^{th} through the 12^{th} grade, the student cannot game the system over such an extensive period of time (unlike a single test). Furthermore, the “progression bands” used in embodiments of the present invention discourage gaming behavior. By gathering data across long periods of time (e.g., many years) and many contexts, embodiments of the present invention also avoid the impact of any one context, such as a “teacher's pet” situation or a family divorce. Embodiments of the present invention thus allow students to be kids, teenagers, and young adults—to rebel, to skip a night of homework, and to be imperfect—without overly punishing them for those behaviors. Instead, the digital signals generated by embodiments of the present invention create an environment in which it is the individual's progress over time that matters the most, and the educational focus can be on improvement rather than judging or worse, penalization.

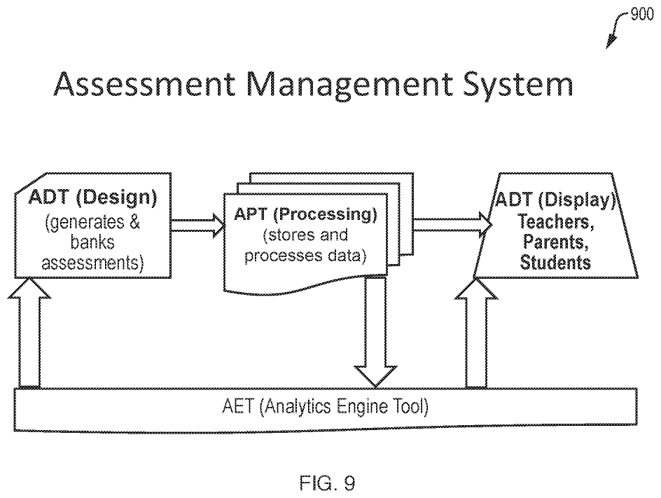

Embodiments of the present invention may, for example, create and maintain the jagged profile 100 for a particular student using an assessment management system 900 of the kind shown in FIG. 9. The assessment management system 900 includes:
an Assessment Design Tool (ADT) component, which generates and banks assessments of the student;
an Assessment Capture Tool (ACT) component, which captures data about the student;
an Assessment User Experience (AUX) component, which outputs (e.g., displays) information about the assessments to a teacher; and
an Analytics Engine Tool (AET), which calculates various analytics disclosed herein.

By way of example, some of the description herein refers to a narrow slice of such digital signals in relation to a particular set of competencies and corresponding sub-competencies. It should be understood that this particular set of competencies and sub-competencies is merely an example, and that embodiments of the present invention may be applied more generally to any set of competencies and/or sub-competencies. The process that was used to find and test the feasibility of digital signals according to the present invention will now be described.

For example, some embodiments of the present invention use the following set of competencies and corresponding sub-competencies:
Creativity:
   CRE1: Generating and seeking new ideas
   CRE2: Developing personal tastes and aesthetics
   CRE3: Being comfortable with risks, uncertainty, and failure
   CRE4: Connecting, reorganizing, and refining ideas into a cohesive whole
   CRE5: Realizing ideas while recognizing constraints
   CRE6: Reflecting on processes and outcomes
Critical Thinking:
   CRI1: Identifying, clarifying, and organizing information
   CRI2: Considering other points of view
   CRI3: Applying sound reasoning to decision-making
   CRI4: Assessing validity and quality of information
   CRI5; Reflecting critically on one's own reasoning and assumptions
Communication:
   COM1: Asking questions and actively listening
   COM2: Clearly and concisely articulating ideas or messages
   COM3: Using and understanding nonverbal and paralingual communication
   COM4: Communicating via multiple modes (e.g., digitally, orally)
   COM5: Empathizing with audiences and adapting messages accordingly
Collaboration:
   COL1: Taking and sharing responsibility with others
   COL2: Utilizing each individual's unique skills and perspectives
   COL3: Navigating and resolving interpersonal conflict
   COL4: Giving and receiving constructive feedback
   COL5: Empathizing with and actively supporting team members
Mindfulness:
   MIN1: Attending to one's body, emotions, and reactions in the present moment
   MIN2: Understanding by describing one's emotions and reactions
   MIN3: Building effective labels for regulation of inner experience
   MIN4: Cultivating positivity, open-mindedness, patience, and compassion
Curiosity:
   CUR1: Seeking to understand deeply
   CUR2: Seeking out novelty and trying new things
   CUR3: Seeking different perspectives to broaden understanding
   CUR4: Actively pursuing one's own interests and passions
Courage:
   COU1: Pursuing ambitious goals despite social, financial, physical, or emotional risk to self
   COU2: Standing up for one's values
   COU3: Engaging with others in a vulnerable way
Resilience:
   RES1: Adapting flexibly
   RES2: Building strong social networks
   RES3: Managing stress and expressing emotions appropriately
   RES4: Orienting to a meaning or purpose
   RES5: Persevering through challenges but seeking help when needed
Ethics:
   ETH1: Identifying and describing ethical concepts
   ETH2: Making ethical decisions and taking ethical actions
   ETH3: Understanding the ethical perspectives of others
   ETH4: Understanding and assessing values, (civil) rights, and responsibilities
Leadership:
   LEA1: Determining challenges and setting goals
   LEA2: Managing power ethically
   LEA3: Thinking strategically to best utilize resources (people and material)
   LEA4: Evaluating team outcomes and adapting accordingly
   LEA5: Respectfully collaborating with others
   LEA6: Contributing to the broader group or community
   LEA7: Sharing one's vision and inspiring others
Metacognition:
   MET1: Reflecting on processes, achievements, learning, and/or identity
   MET2: Determining goals, plans to achieve those goals, and monitoring one's progress
   MET3: Monitoring comprehension and managing information accordingly
   MET4: Evaluating one's actions and their consequences
   MET5: Considering alternatives and different perspectives
   MET6: Practicing awareness and regulation of internal state
   MET7: Thinking and adapting flexibly
Growth Mindset:
   GRO1: Believing in one's agency and having high-self efficacy
   GRO2: Learning from mistakes and welcoming feedback as a chance to grow
   GRO3: Persevering for deeper expertise and understanding
   GRO4: Understanding one's current strengths and weaknesses
   GRO5: Finding joy in learning and becoming a lifelong learner

Some of the following discussion will refer to the competency of Collaboration, solely as an example and for ease of explanation. The description herein is equally applicable to any competency (e.g., any of the competencies in the profile 100 of FIG. 1) and to any combination of competencies (e.g., some or all of the competencies in the profile 100 of FIG. 1). In the following description, Collaboration will be described as including five sub-competencies, solely for purposes of example and not as a limitation of the present invention. These five sub-competencies may be thought of as five levers; when all five levers are pressed down at the same time, Collaboration can occur. The act of pushing down all five layers at once, however, is an incredibly difficult task. For ease of explanation, the five sub-competencies of Collaboration will be referred to herein as COL1, COL2, COL3, COL4, and COL5. Any of the other competencies may have its own set of one or more sub-competencies. The table below provides example descriptions of the five sub-competencies COL1, COL2, COL3, COL4, and COL5.

| | | |
|---|---|---|
| COLLABORATION | COL1: Taking and | There is a delicate and dynamic balance to be |
| | sharing responsibility | struck between taking initiative in a group |
| | with oters | and expanding one's awareness to the |
| | | functioning of the group as a whole, taking |
| | | on what responsibilities are needed. This |
| | | includes working flexibly with others, as |
| | | various factors in the group work change, and |
| | | allowing others to take responsibilities for |
| | | aspects of the work. |
| | COL2: Utilizing each | What makes collaboration greater than just |
| | individual's unique | multiple people working in parallel is that the |
| | skills and perspectives | group can benefit from the unique skills and |
| | | perspectives of its members. They can check |
| | | each other’s' biases, they can be creative in |
| | | completely different ways, and they can |
| | | simply benefit from a division of labor in |
| | | which each person gets to do what they are |
| | | best at, contributing the highest possible |
| | | value to the collective goal. Seeing the ways |
| | | in which people's perspectives, strengths, and |
| | | weaknesses fit together is crucial to good |
| | | collaboration. |
| | COL3: Navigating and | The moments that collaboration is difficult |
| | resolving interpersonal | often involve different sorts of interpersonal |
| | confict | conflicts. No matter one's level of expertise, |
| | | this is going to be a consistent challenge that |
| | | will need to be overcome over and over, in |
| | | group after group. Overcoming this challenge |
| | | is a set of habits and practices that can be |
| | | trained and improved upon. |
| | COL4: Giving and | In any group, people are going to have |
| | receiving constructive | opinions about each others' work, and to stay |
| | feedback | on the same page and to be able to benefit |
| | | from each others' perspectives, it's important |
| | | to be able to give and take constructive |
| | | feedback effectively. Both formulating |
| | | feedback and receiving it gracefully do not |
| | | come naturally, and need to be trained. |
| | COL5: Empathizing | In order to understand what everyone can |
| | with and actively | contribute, how people feel about the group |
| | supporting team | work, and so on, it's important to be able to |
| | members | empathize. Additionally, sometimes active |
| | | steps are needed to ensure every team |
| | | member feels supported and contributes. |

The sub-competencies provide a structure that instructors, students, and individuals may use to more effectively and efficiently target individual Collaboration skills, with the design that once each individual skill is mastered, Collaboration will be more attainable. Of course, each sub-competency builds on and feeds into the next; they do not exist in isolation.

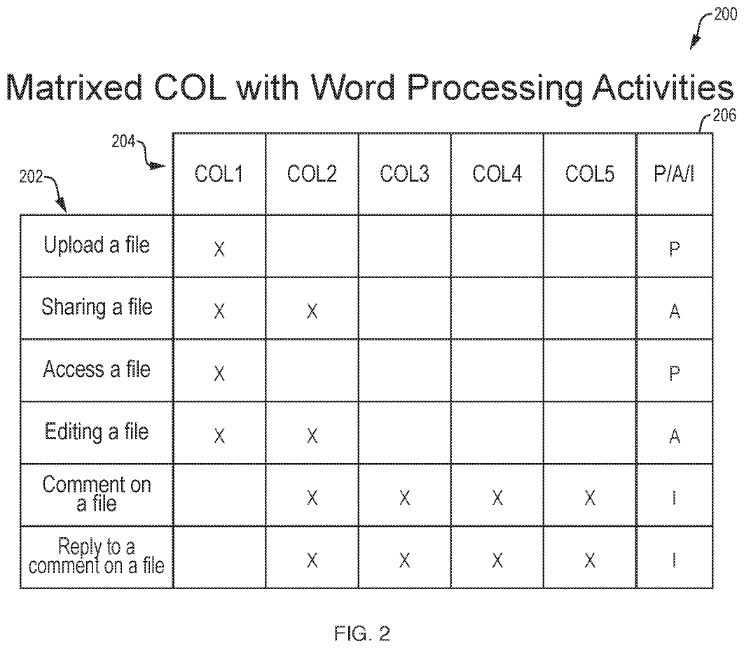

FIG. 2 shows an example of what is referred to herein as a “sub-competency matrix” 200 for the Collaboration competency in connection with use of document-generating software, such as Microsoft Word or Google Docs. The sub-competency matrix 200 indicates, for each of the Collaboration sub-competencies, which of a plurality of features express that sub-competency. More specifically, the sub-competency matrix 200 includes a plurality of rows 202, each of which corresponds to a distinct digital activity. In the particular example of FIG. 2, the digital activities are digital activities which are possible to perform using the document-generating software, namely: “Upload a File,” “Share a File,” “Access a File,” “Edit a File,” “Comment on a File,” and “Reply to a Comment on a File.” This particular set and number of digital activities are merely examples and are not limitations of the present invention. More generally, the sub-competency matrix 200 may include rows representing any number of any combination of digital activities, including digital activities not shown in FIG. 2.

The sub-competency matrix 200 also includes a plurality of columns 204, each of which corresponds to a distinct sub-competency of the Collaboration competency. In the particular example of FIG. 2, those sub-competencies are COL1, COL2, COL3, COL4, and COL5, as described above. This particular set and number of sub-competencies are merely examples and are not limitations of the present invention. More generally, the sub-competency matrix 200 may include columns representing any number of any combination of sub-competencies, including sub-competencies not shown in FIG. 2.

Each cell C_{AS} in the matrix 200 is at the intersection of a particular row (representing a particular digital activity A) and a particular column (representing a particular sub-competency S). Each such cell C_{AS} may contain a binary value indicating whether the performance of digital activity A by an individual could provide an opportunity for the individual to practice/express/attain sub-competency S. In FIG. 2, an “X” in a cell C_{AS} represents a value of “Yes” or “True” (e.g., that the performance of digital activity A by an individual is an indicator that the individual has sub-competency S); an empty cell C_{AS} represents a value of “No” or “False” (e.g., that the performance of digital activity A by an individual is not an indicator that the individual has sub-competency S).

As the example of FIG. 2 illustrates, any particular sub-competency may be indicated by some of the digital activities and not others (or to a greater or lesser degree by some of the digital activities than others). One example of this is the COL1 sub-competency, which is indicated by four of the digital activities and not by two of the digital activities. As the example of FIG. 2 further illustrates, different sub-competencies may be indicated by different sets of digital activities. One example of this is that the COL1 sub-competency is indicated by a different set of digital activities than the COL2 sub-competency.

Finally, the P/A/I column 206 indicates whether the corresponding digital activity is passive, active, or interactive in terms of its collaborative quality and potential. The interactive digital actions are those that most profusely practice collaboration. For purposes of example and without limitation, “Upload a File” is shown as passive; “Share a File” is shown as active; “Access a File” is shown as passive; “Edit a File” is shown as active; “Comment on a File” is shown as interactive; and “Reply to a Comment on a File” is shown as interactive. The use of the P/A/I column 206 is merely an example and is not required in all embodiments of the present invention.

The particular digital activities 202 shown in FIG. 2 are common digital activities that occur on any file/document sharing platform, such as sharing a document, uploading a file, editing a file, and commenting on a file. As shown in FIG. 2, we mapped each such digital activity to the potential sub-competencies it could indicate. For example, “Upload a File” is most directly related to COL1: Taking and sharing responsibility with others (as indicated by the “X” in the cell at the intersection of “Upload a File” and “COL1”).

As described above, the matrix 200 shown in FIG. 2 corresponds to the competency of collaboration. Similar matrices may exist for some or all of the other competencies (e.g., some or all of the competencies shown in FIG. 1). Any of the techniques disclosed herein in connection with FIG. 2 and the competency of collaboration may be performed, additionally or alternatively, in connection with some or all of the competencies.

In our analysis, we took two approaches: an optimistic view, and a more realistic view (often fueled by anecdotal experiences or by research). For this example of “Upload a File,” the optimistic view is that this is the first step in effectively sharing responsibility; a more realistic view is that this action does not necessarily mean that responsibility is being dispersed—and, furthermore, digital limitations mandate that one individual is still the “owner” of a file, a concept which directly contradicts Collaboration.

The use of binary values in the cells of the matrix 200 is merely an example and does not constitute a limitation of the present invention. Alternatively, for example, each cell C_{AS} may include a non-binary value (e.g., an integer or percentage) indicating a degree to which the digital activity A is an indicator that the individual has sub-competency S.

As another example, embodiments of the present invention may assign a weight to each of the rows 202 (e.g., digital activities) in the matrix 200. The weight assigned to a row may represent the degree to which the corresponding digital activity provides an opportunity for the competency represented by the matrix 200 (e.g., Collaboration). For example, passive activities (e.g., rows with a value of “P” in the P/A/I column 206) may be assigned the lowest weight; interactive actions (e.g., rows with a value of “I” in the P/A/I column 206) may be assigned the highest weight; and active actions (e.g., rows with a value of “A” in the P/A/I column 206) may be assigned a weight that is greater than the weight assigned to passive activities and lower than the weight assigned to interactive activities. (This particular assignment of weights to rows 202 is merely an example and does not constitute a limitation of the present invention.) By this logic, commenting on a file demonstrates a more advanced Collaborative skill than merely uploading a file into a shared space. In a digital space, the commenting feature is notably the most interactive, and therefore most weighted, action. A threaded discussion in the comments is the closest to true, synchronous collaboration that file sharing platforms can reach. However, inverse logic may also be used: a user should not be heavily penalized by others' unwillingness to engage, so a number of these weights may follow other curves (diminishing returns, or n-shaped, etc.) In other words, more of a given parameter is not always better, and the system described here is flexible enough to allow a variety of fit curves.

Embodiments of the present invention may generate an instance of the integrated assessment 1212 for the student 1202 by assigning corresponding weights to the individual assessments 1208a-n, and then calculating a weighted sum of those assessments 1208a-n. In other words, if assessment 1208a is labeled as A₁ and has weight W₁, then the system 1200 may calculate a weighted score for assessment 1208a as A₁W₁ (i.e., by multiplying A₁ by W₁). The system 1200 may do the same for the remaining assessments 1208b-n and their corresponding weights, and then sum all of the resulting weighted scores to produce a weighted sum, which may be used as, or within, the integrated assessment 1212. The system 1200 may repeat such a process at a plurality of times, during which some or all of the individual assessments 1208a-n may change, which may result in different integrated assessments 1212 at some or all of those plurality of times.

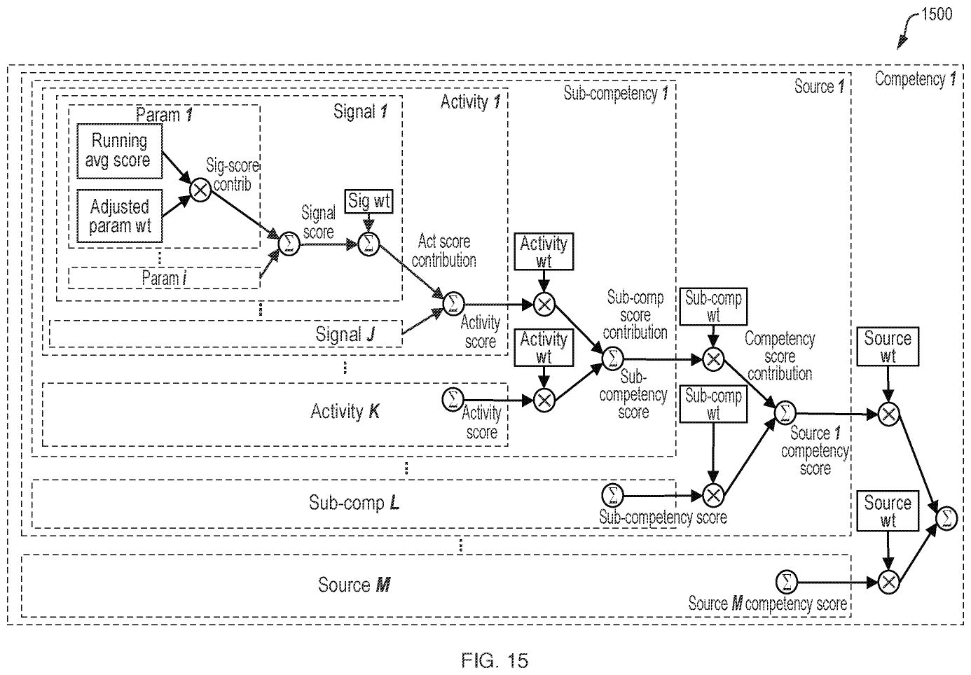

FIG. 15 shows merely one example of a portion of such a calculation that may be performed according to one embodiment of the present invention. FIG. 15 illustrates a calculation that is performed for a single competency (shown as “Competency 1”) for the student 1202. It should be understood that the system 1200 may perform the same calculations for one or more additional competencies for the student 1202, and that any of the weights and other values described herein in connection with FIG. 15 may vary from competency to competency. In the particular example of FIG. 15:
Competency 1 includes a plurality of sources (which may, for example, be some or all of the sources shown in FIG. 10), shown as Source 1-Source M, where M may be any value. Each of the plurality of sources has its own corresponding weight and competency score. The system 1200 calculates a weighted sum of the competency scores for the plurality of sources within Competency 1, i.e., by multiplying each of those competency scores by its corresponding source weight to produce weighted source scores, and then summing the weighted source scores. The resulting weighted sum is a competency score for Competency 1.
Source 1 includes a plurality of sub-competencies, shown as Sub-competency 1-Sub-competency L, where L may be any value. Each of the plurality of sub-competencies has its own corresponding weight and sub-competency score. The system 1200 calculates a weighted sum of the sub-competency scores for the plurality of sub-competencies within Source 1, i.e., by multiplying each of those sub-competency scores by its corresponding sub-competency weight to produce weighted sub-competency scores, and then summing the weighted sub-competency scores. The resulting weighted sum is a source competency score for Source 1. The system 1200 may use the same techniques to calculate source competency scores for Sources 2-M.
Sub-competency 1 includes a plurality of activities, shown as Activity 1-Activity K, where K may be any value. Each of the plurality of activities has its own corresponding weight and activity score. The system 1200 calculates a weighted sum of the activity scores for the plurality of activities within Sub-competency 1, i.e., by multiplying each of those activity scores by its corresponding activity weight to produce weighted activity scores, and then summing the weighted activity scores. The resulting weighted sum is a sub-competency score for Sub-competency 1. The system 1200 may use the same techniques to calculate source sub-competency scores for Sub-competencies 2-L.
Activity 1 includes a plurality of digital signals, shown as Signal 1-Signal J, where J may be any value. Each of the plurality of digital signals has its own corresponding weight and activity score. The system 1200 calculates a weighted sum of the digital signal scores for the plurality of digital signals within Activity 1, i.e., by multiplying each of those digital signal scores by its corresponding activity weight to produce weighted digital signal scores, and then summing the weighted digital signal scores. The resulting weighted sum is an activity score for Activity 1. The system 1200 may use the same techniques to calculate source activity scores for Activities 2-K.
Signal 1 includes a plurality of parameters, shown as Parameter 1-Parameter I, where I may be any value. Each of the plurality of parameters has its own corresponding weight and activity score. The system 1200 calculates a weighted sum of the parameter scores for the plurality of parameters within Signal 1, i.e., by multiplying each of those parameter scores by its corresponding parameter weight to produce weighted parameter scores, and then summing the weighted parameter scores. The resulting weighted sum is a signal score for Signal 1. The system 1200 may use the same techniques to calculate source signal scores for Signals 2-J.

For a given competency, the weights across all of the competency's sub-competencies may be required to add up to 1.0, since each sub-competency reflects an “implication strength” with which that sub-competency is an indicator of performance at the competency level. For any given set of weights, the relative contribution (implication strength) may be captured on a range of arbitrary breadth, such as 0 through 10. A normalization scheme may then be applied to automatically convert each such weight to a value in the normalized range (e.g., 0 through 10).

Although the highest level in FIG. 15 is that of Competency, the system 1200 may use similar techniques to calculate a plurality of weighted competency scores to generate discipline scores, to calculate a plurality of weighted discipline scores to generate grade scores, to calculate a plurality of weighted grade scores to generate student scores, and to calculate a plurality of weighted student scores to generate institution scores, jurisdiction-level scores, and global-level scores.

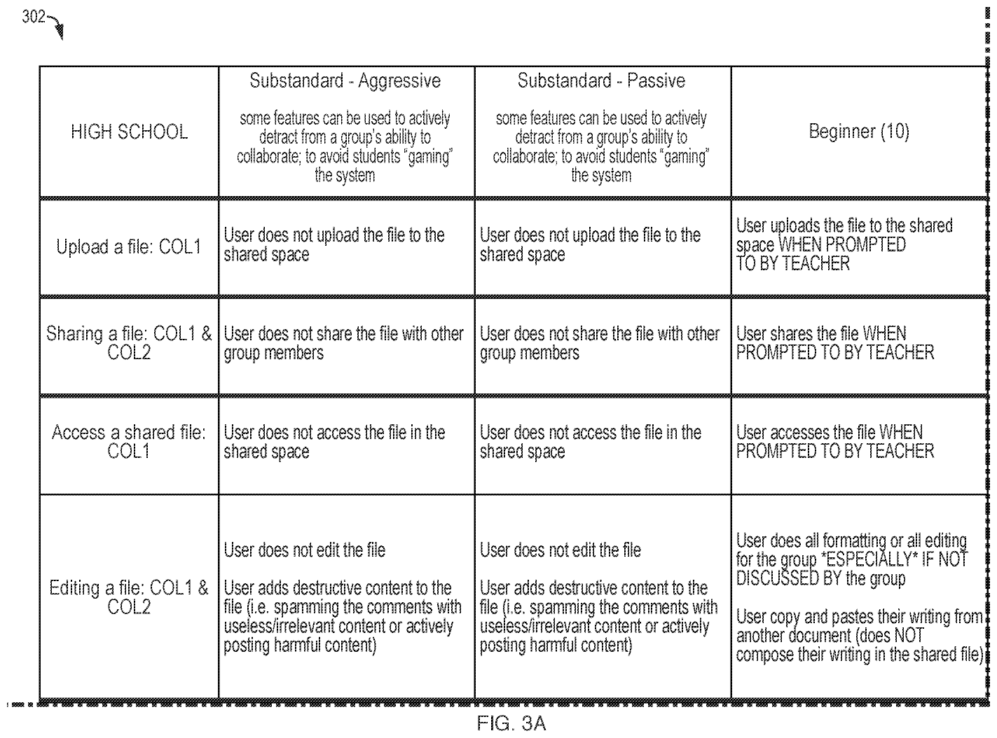

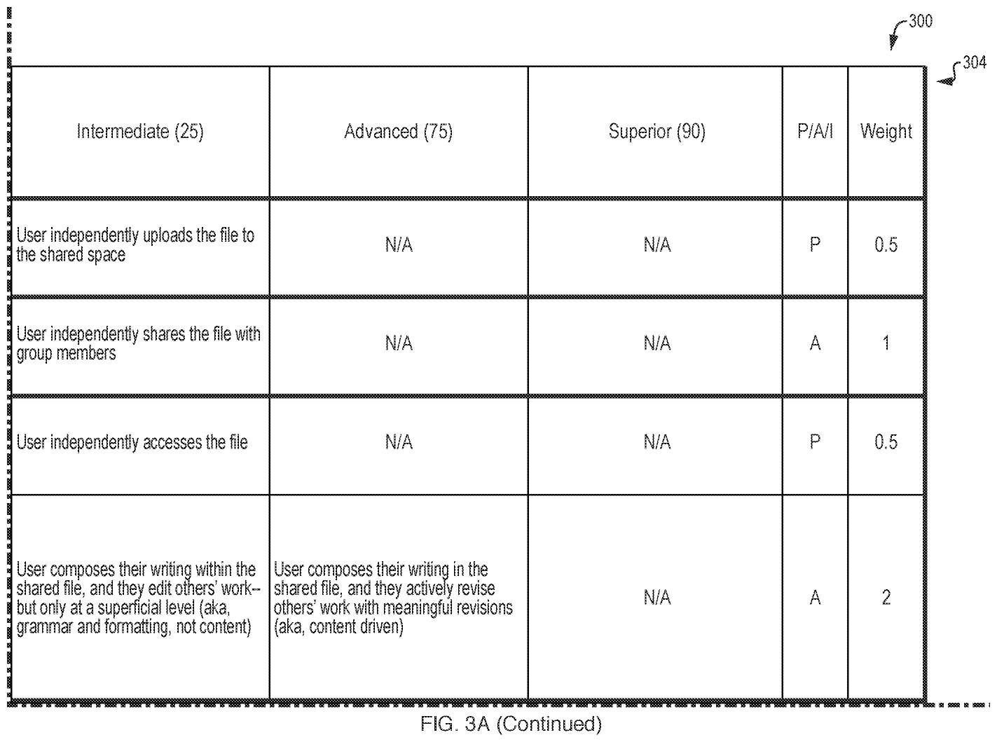

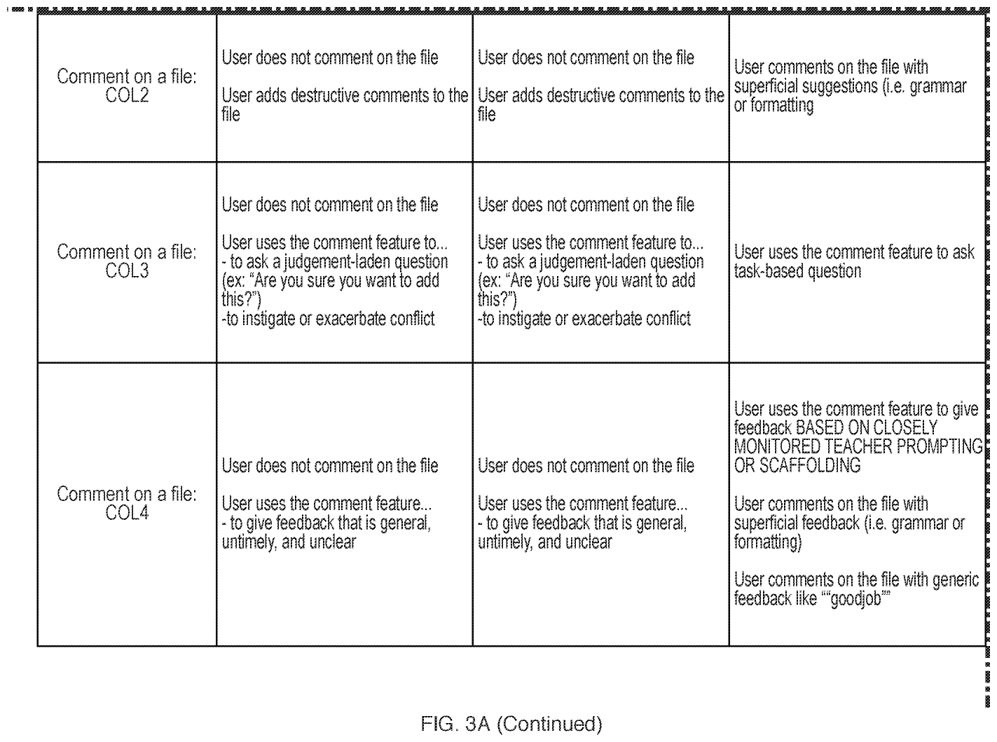

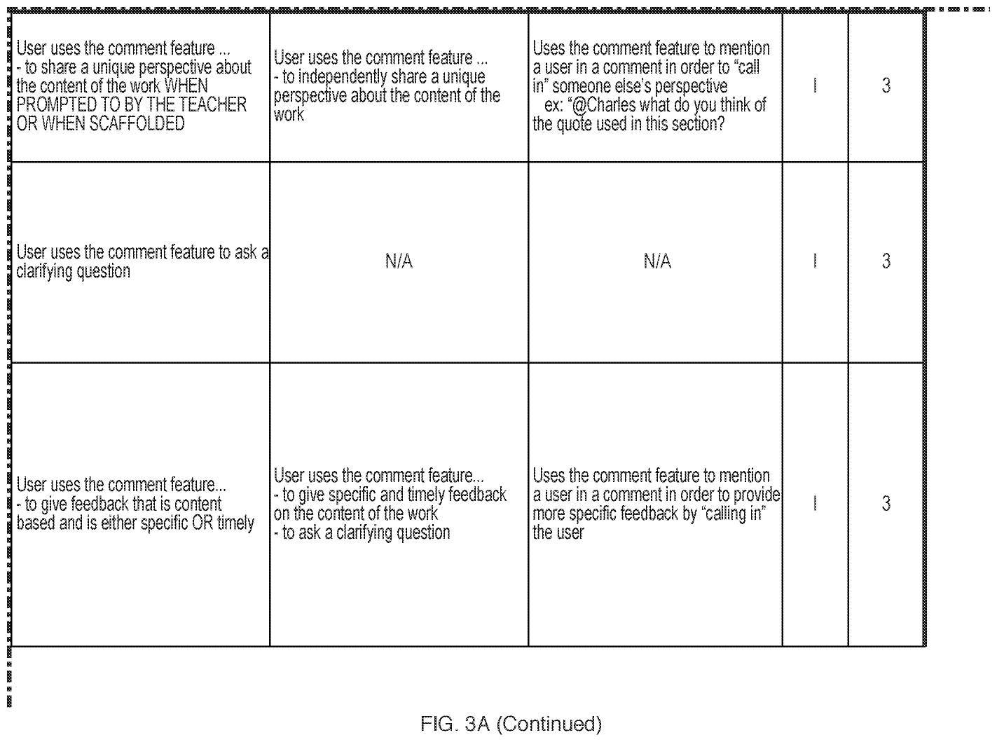

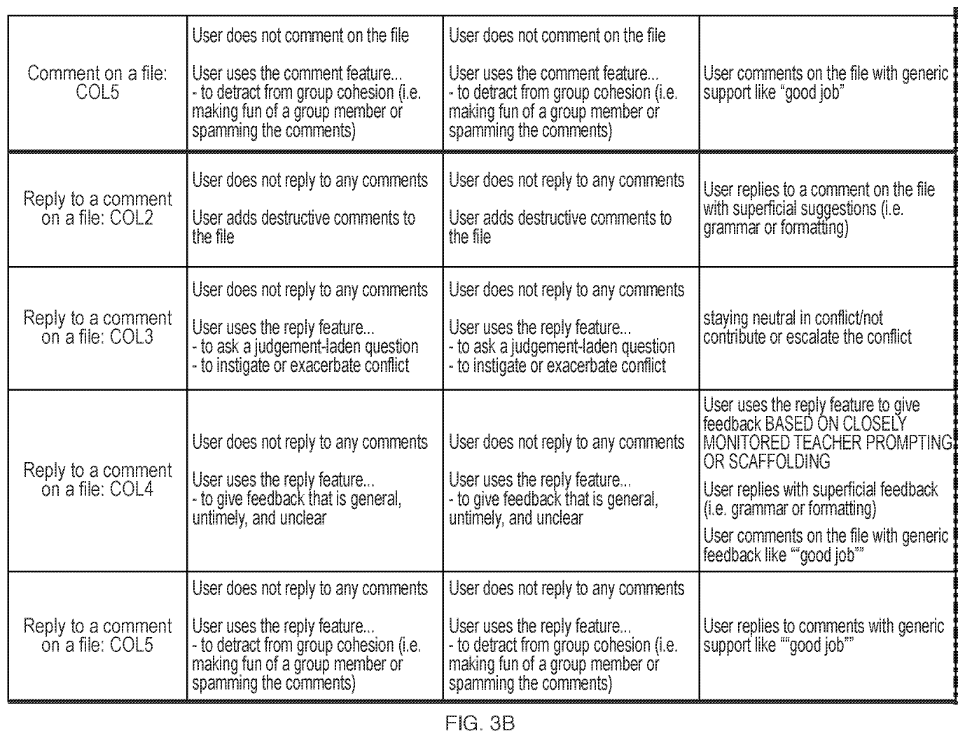

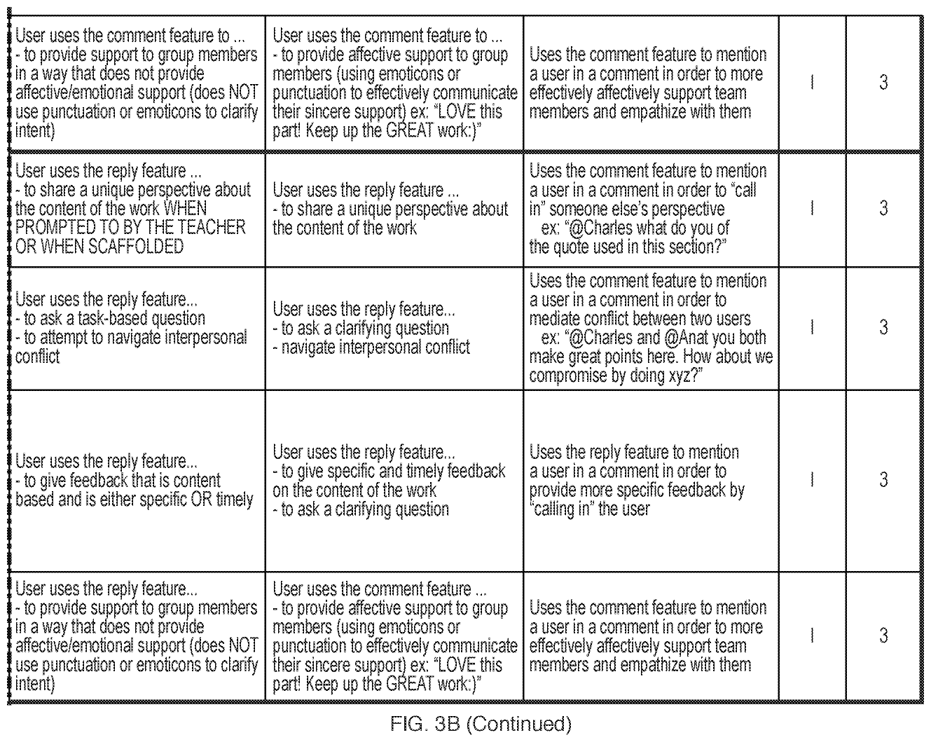

Quality bands/progressions may be created for the matrix 200 of FIG. 2. In general, the terms “quality band” and “progression” are used interchangeably herein to refer to an ordered sequence of assessment bands that correspond to a particular combination of competency (or sub-competency, or set of sub-competencies) and digital activity. The terms “assessment band,” “progression level,” “proficiency level,” and “level” refer synonymously herein to a label (e.g., assessment score or range of assessment scores) that may be assigned to a student in connection with a particular progression. As a particular example, and as will be described in more detail below in connection with FIGS. 3A and 3B, one quality band may correspond to a combination of the COL1 sub-competency and the “Upload a file” digital activity, and may include the following ordered sequence of assessment bands: “Substandard-Aggressive,” “Substandard-Passive,” “Beginner” (which may correspond to an assessment score of 10-24), “Intermediate” (which may correspond to an assessment score of 25-74), “Advanced” (which may correspond to an assessment score of 75-89), and “Superior” (which may correspond to an assessment score of 90-100). An assessment band may include, for example, a textual label, a numerical score, or both.

Some of the intersections of digital activity and sub-competency were combined into one progression, because they rely too heavily on the individual's intent. For example, “Share a File” may be a manifestation of COL1 and/or COL2, but it is not possible to know whether the student's intent was to manifest COL1 and/or COL2 based merely on an observation that the student engaged in the “Share a File” activity. Conversely, a student may engage in the “Comment on a File” activity for a variety of distinct purposes, which is why the progressions for COL2, COL3, COL4, and COL5 are all separate for the “Comment on a File” activity.

Embodiments of the present invention may, for example, use two tables (e.g., one qualitative, one quantitative) to represent the progressions described above. The first table represents an overview, for each pair of digital activities A and sub-competencies S, of how a student would engage in digital activity A to demonstrate sub-competency S, for each of a plurality of levels L of the progression. The second table represents more detailed, example-driven progressions and thereby includes specific examples of tasks that the student may perform within each level of each progression. In practice, these two tables may be combined into a single table.

For example, FIGS. 3A-3B show an example of the first type of table 300 according to one embodiment of the present invention. Solely for purposes of example and without limitation, the table 300 represents a series of twelve progressions 302 for the Collaboration competency. Each of the twelve progressions 302 has four assessment bands 304 (also referred to as “proficiency levels”) within it, labeled in FIGS. 3A-3B as “Beginner,” “Intermediate,” “Advanced,” and “Superior.” The particular number and labels of the progressions 302 and levels 304 shown in FIGS. 3A-3B are merely examples and do not constitute limitations of the present invention. The contents of the cells in FIGS. 3A and 3B describe tasks that may be performed by the student 1200 within software executing on a computer (e.g., word processing).

To illustrate the nature of the table 300, consider the first of the progressions 302, corresponding to the digital activity/sub-competency pair of “Upload a File”/COL1. As indicated in the column labeled “Beginner,” representing the Beginner level of the “Upload a File”/COL1 progression, a student would manifest the Collaboration competency at the Beginner level of the “Upload a File”/COL1 progression by uploading a file to a shared space when prompted by a teacher to do so. Similarly, as indicated in the column labeled “Intermediate,” representing the Intermediate level of the “Upload a File”/COL1 progression, a student would manifest the Collaboration competency at the Intermediate level of the “Upload a File”/COL1 progression by independently uploading a file to the shared space (e.g., without being prompted by the teacher to do so). In the particular example of FIGS. 3A-3B, there is no action of the student that would indicate that the student manifests the Collaboration competency at the Advanced or Superior levels of the “Upload a File”/COL1 progression.

In general, embodiments of the present invention may use a table, such as the table 300 of FIGS. 3A-3B, to observe digital activities of a student and, based on such observed digital activities, to assign one or more progressions, and a corresponding assessment band within each of those progressions, to the student. Consider that each cell in the table 300 of FIGS. 3A-3B:
represents a particular task T that may be performed by a student (e.g., “Uploads a file to a shared space when prompted by the teacher”);
corresponds to a particular digital activity A (e.g., “Upload a File”);
corresponds to a particular sub-competency S (e.g., COL1); and
corresponds to a particular progression level L (e.g., “Beginner”).

Embodiments of the present invention may observe each of a plurality of digital activities performed by the student and determine whether, for each cell C in the table 300, that digital activity is an example of the task T defined by cell C. If so, then embodiments of the present invention may identify the progression level L, activity A, and sub-competency S associated with cell C, and assign to the user the progression level L within the progression defined by the combination of activity A and sub-competency S.

The techniques shown and described in connection with FIGS. 3A-3B may be used to implement aspects of the system 1200 of FIG. 12 and the method 1300 of FIG. 13. For example, assigning a progression level of FIGS. 3A-3B to the student 1202 based on a digital activity performed by the student 1202 is an example of generating one of the assessments 1208a-n based on the student output 1204 in FIGS. 12-13. More specifically, the digital activity performed by the student 1202 in FIGS. 3A-3B is an example of the student output 1204 in FIG. 12, and the progression level assigned to the student 1202 in FIGS. 3A-3B is an example of one of the assessments 1208a-n in FIG. 12.

More generally, using the techniques disclosed in connection with FIGS. 3A-3B to assign a plurality of progressions, and levels within those progressions, to the student 1202 based on one or more digital activities performed by the student, is an example of generating one or more of the assessments 1208a-n based on the student output 1204 in FIGS. 12-13.

As mentioned above, embodiments of the present invention may also divide grades into a plurality of bands. Such grade bands are merely an example of bands that may be applied to any periods of time in the lives of students; as a result, the terms “grades” and “grade bands” should be understood more generally to refer to any time periods, whether or not related to grades. For example, in some embodiments of the present invention, there are two grade bands: one for 5^{th}-8^{th} grade, and one for 9^{th}-12^{th} grade. These two particular bands are merely examples and do not constitute limitations of the present invention. More generally, embodiments of the present invention may use any number of grade bands, each of which may represent any number of consecutive grades. The particular grade bands of 5^{th}-8^{th} and 9^{th}-12^{th} grade were chosen because many cognitive developments occur between 8^{th} and 9^{th} grade for many students. Similarly, students typically do not have the cognitive or technical skills before grade 5 to significantly collaborate using digital platforms. That being said, we recognize that these bands are more heavily correlated with a student's abilities rather than their age or grade level. Many times, students' abilities coincide with their grade/age, but this is not always the case.

Embodiments of the present invention may weight a student's ability in connection with a competency (e.g., Collaboration) and/or sub-competency based on the student's grade. For example, the degree to which a student collaborates in 5^{th} grade may hold less sway over that student's collaborative digital signal than the degree to which the student collaborates in 12^{th} grade. In other words, embodiments of the present invention may assign different weights to different grades.

In some embodiments of the present invention, there are seven progression levels: four are positive, and three are sub-standard (e.g., destructive, aggressive, and passive). The positive progression levels include, in the following order: Beginner, Intermediate, Advanced, and Superior. Not all progression levels need be available for all digital activities. For example, in the table of FIGS. 3A-3B, there is no Advanced or Superior progression level for the “Upload a File”: COL1 progression.

The substandard progression levels may, for example, be differentiated by their level of aggression, such as: passive, active, and destructive. The passively aggressive level (shown as “Standard-Passive” in FIGS. 3A-3B) is mostly marked by a student's lack of engagement; e.g., the student does not edit the file, or open the file, or comment on the file. The actively aggressive level (shown as “Standard-Aggressive” in FIGS. 3A-3B) indicates that a student is actively engaged, but that the student is actively detracting from a group's ability to collaborate; such as when a student makes fun of another student in a comment. The final, destructive, level is reached when a student deliberately stops a group from being able to collaborate; for example, when a student uploads a virus into a shared file.

The substandard progression levels also help to ensure that students cannot game the system, because more of a behavior does not necessarily indicate more skill. Instead, the substandard progression levels encourage students neither to perform an activity too much (e.g., by bombarding the file with comments) nor to perform it too infrequently (e.g., by only commenting once).

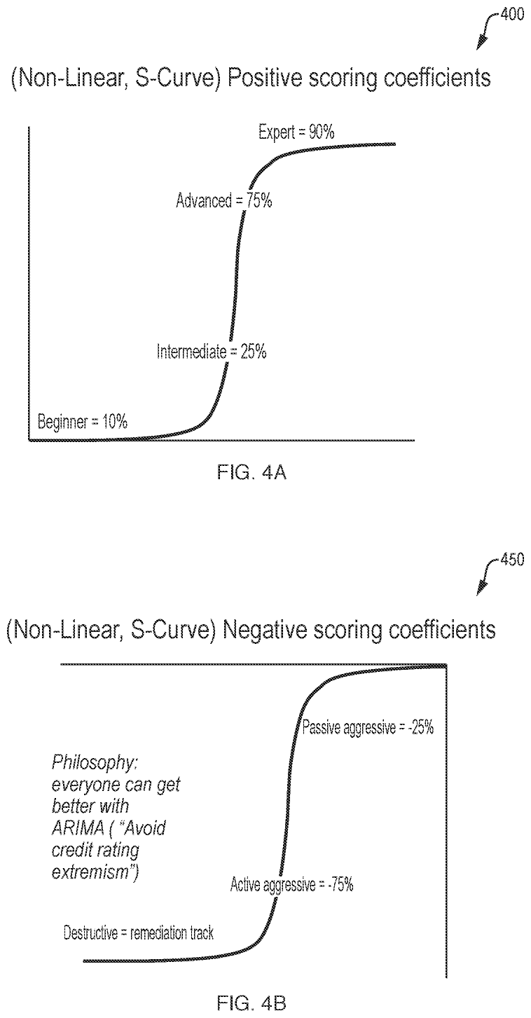

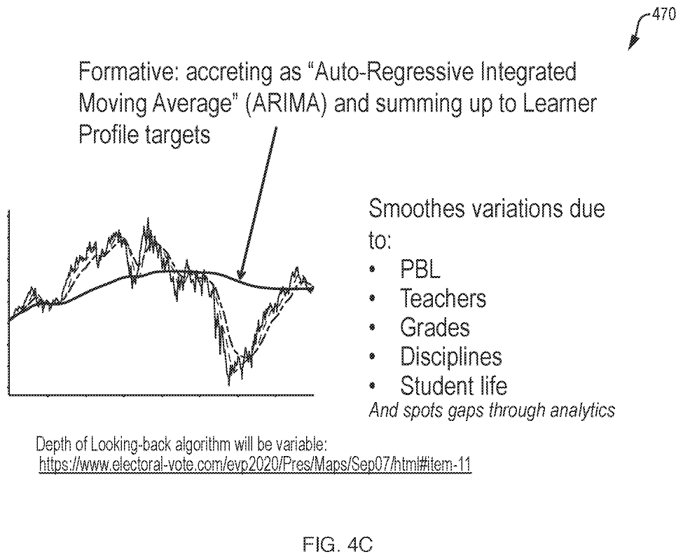

Embodiments of the present invention may apply a plurality of curves to the progression levels (including both the positive and substandard progression levels), not just linear progressions. An example of such a curve 400 for the positive progression levels is shown in FIG. 4A. An example of such a curve 450 for the substandard progression levels is shown in FIG. 4B. The X axes in FIGS. 4A and 4B are the progression bands and percentiles at which a student is performing, and the Y Axes represent the student's proficiency level. An S-curve would best represent the nuances of the proficiency levels (also referred to herein as “progression levels”). The S-curve accurately represents how it is much more difficult to move from Intermediate to Advanced than from Beginner to Intermediate, or from Advanced to Superior. This shape matters, as the amount of time to spend teaching the student to conquer the steep ramp-up is the derivative of the S-curve—the Bell curve.

Similarly, by applying statistical techniques including but not limited to ARIMA (auto-regressive integrated moving average) to the overall data (e.g., the student output 1204 in FIG. 12, or a subset of the student output 1204, such as the subset of the student output 1204 relating to a particular competency or sub-competency), embodiments of the present invention may ensure that a student is not overly punished for any singular or extreme success or failure (e.g., due to a life event, specific classroom circumstances, etc.). An example of this is shown in the graph 470 of FIG. 4C. The depth of the ARIMA may be variable, and it may, for example, either be constant or extend throughout the student's life up to a certain number of years.

We selected “Edit a File” as the narrow slice within the Collaboration competency in order to demonstrate proof of concept of the present invention. As shown in the matrix 200 of FIG. 2, “Edit a File” intersects with COL1 and COL2. The progressions illustrated in the table 300 of FIGS. 3A-3B represent qualitative measures. Our next step was to move these qualitative metrics into quantitative measurements.

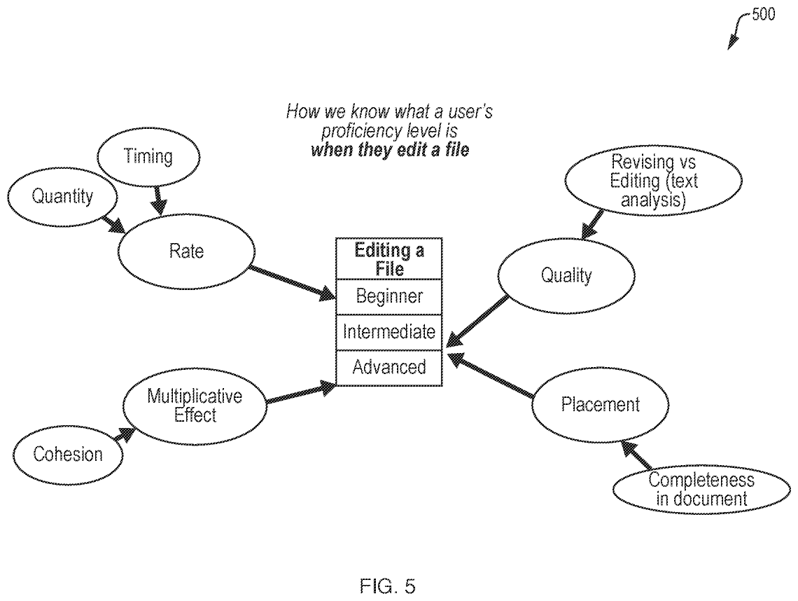

FIG. 5 shows examples of parameters whose values may be measured, based on a student's use of the digital action, “Edit a File.” Embodiments of the present invention may assign a progression level to the student based on the measured parameter values, as will now be described.

In FIG. 5, “rate” is a parameter that refers to the quantity of words and/or content a student uploads to a file over a period of time. (More generally, embodiments of the present invention may measure a rate at which the student performs any digital activity to generate a value of the rate parameter in relation to that digital activity.) The rate can tell us several things about a student's collaborative performance. For example, if a student uploads 600 words to a document in 21 seconds, this indicates that the student has likely copied-and-pasted their work from another document. As a result, the student is not truly creating their work in the shared file, which removes the opportunity for collaboration. Similarly, if a student uploads 10 words in 1 hour, then this is likely an indication that the student is revising or editing their group's work. This is an indicator that true collaborative behavior may be occurring.

In FIG. 5, “quality” is a parameter that refers to the quality of the edits made by the student. (More generally, embodiments of the present invention may measure a quality of any digital activity performed by the student to generate a value of the quality parameter in relation to that digital activity.) Higher quality edits demonstrate a student's collaborative ability. Through the lens of “Edit a File,” the quality metric is used by embodiments of the present invention mainly to differentiate between editing and revising. Editing refers to correcting smaller, grammatical/spelling mistakes; the latter is a much more engaged process of reshaping and molding another's work.

Embodiments of the present invention may use any of a variety of computer-automated text analysis techniques to identify a value of the “quality” parameter based on text input received from the student 1202. Such techniques may include, for example, any of a variety of algorithms incorporating but not limited to, Artificial Intelligence (AI), and/or Machine Learning (ML), and/or Natural Language Processing in any combination. Such techniques may, for example, analyze text input received from the student 1202 (such as comments made by the student 1202 within a document and/or additions/edits made by the student 1202 to the document) to identify a value of the “quality” parameter. Such techniques may, for example, determine how collaborative the student 1202 is being based on the text input received from the student 1202, and assign a value of the “quality” parameter that is a function (e.g., an increasing function) of the identified degree of collaboration.

As a particular example of the above, consider three alternative cases, in which the student 1202 provides one of each of the following three comments within a document:
“I see where you're coming from, but I'm not sure if you're right. Looks good though.”
“I think you have the right idea, but maybe they need to be more specific.”
“I'm wondering how you determined the length of each activity. What criteria were you using?”

Note that, in this example, each of the three comments contains the same number of words. A naïve approach, which merely relied on the number of words to evaluate the student 1202's COL4 sub-competency (i.e., giving and receiving constructive feedback), would assign the same value to each of these three comments. Embodiments of the present invention may, however, use any of the kinds of automated text analysis disclosed herein to evaluate these three comments based on their content and to assign values (assessments) based on that evaluate. This may, for example, result in a higher value (assessment) for the second comment than for the first comment because the content of the second comment indicates greater skill at giving and receiving constructive feedback than the first comment, and may result in a higher value (assessment) for the third comment than for the first comment, because the content of the third comment indicates greater skill at giving and receiving constructive feedback than the second comment. This is merely one example of a way in which embodiments of the present invention may automatically generate assessments of the student 1202 based on the content of the student input 1204 by applying computer-automated text analysis techniques to that content.

In FIG. 5, “placement” is a parameter that refers to the locations at which the student edits the file. (More generally, embodiments of the present invention may measure placement by the student of any physical or digital object in the performance of any digital activity.) Where the student edits the file can also tell us a lot about the student's collaborative capacity. For example, if the student provides quality revisions, but only to the first page of the document, then that student's collaborative capacity is more limited than if they had provided quality revisions to the entire document. Furthermore, the placement of the student's edits and revisions can also tell us how a student is interacting with their fellow students' work.

In FIG. 5, “multiplicative effect” is a parameter that refers to the increase in collaborative capacity that occurs when more members of the group edit, revise, and interact with a specific part of a file. (More generally, embodiments of the present invention may measure a multiplicative effect resulting from performance of any digital activity by a plurality of students.) In other words, if three members interact with a paragraph written by another student, this demonstrates more collaboration than if only one member re-read it.

In general, embodiments of the present invention may use any of the techniques disclosed herein to generate, based on one or more of the parameter values shown in FIG. 5, one or more assessments of the student, and to assign a progression and corresponding progression level to the student, based on those assessments.

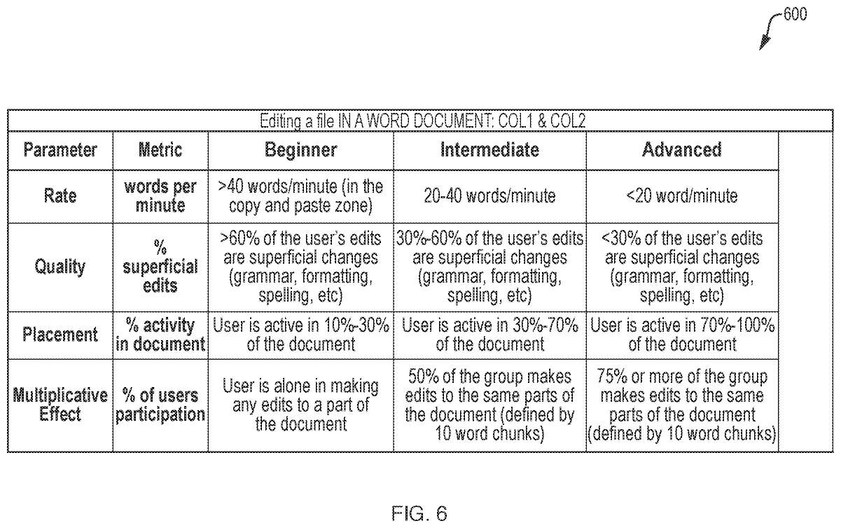

The signals shown in FIG. 5 may be weighted and even further quantified, as illustrated by the table in FIG. 6. The particular weightings and quantifications shown in FIG. 6 are merely examples and do not constitute limitations of the present invention. As shown in FIG. 6, the signals receive different weights, depending on the assignment or the instructor. However, the multiplicative effect could be given less weight than the others, so as not to punish group members who are contributing if their peers refuse to do so.

The specific quantities shown for Beginner, Intermediate, and Advanced progression levels in FIG. 6 are educated estimates of their ranges, and may be modified over time, e.g., as the system learns the averages from a cluster of students, and by using teachers, other assessment methods (summative or formative), or other experts to cross-validate the behaviors.

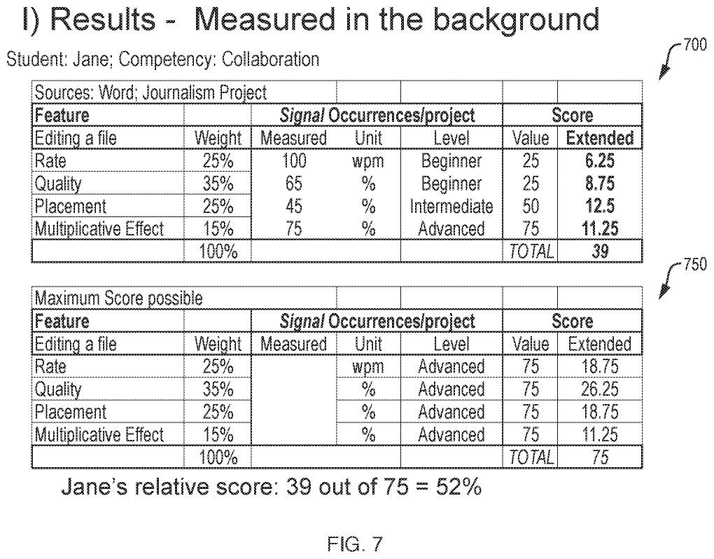

Embodiments of the present invention may use the signals, quantifications, and weightings described above to generate a total Collaboration score for any given student. FIG. 7 is a table 700 which represents how a score may be produced for a student within the narrow slice of “Edit a File.”

The process used to generate the student's score of 39 in the first table 700 of FIG. 7 involves a series of multiplications, weights, and values that show how a student performed compared to what was possible for them to achieve. Ultimately, the sum of a student's Collaboration score—the many signals, digital activities, sub-competencies, weights, and projects—may be shown to instructors and students alike in order for them to better assess and teach collaborative abilities.

The second table 750 illustrates, for purposes of comparison with the first table 700, the maximum possible score that a student could achieve. In the example of FIG. 7, the maximum possible score is 75, which would be achieved if a student had a rate of 75, a quality of 75, a placement of 75, and a multiplicative effect of 75.

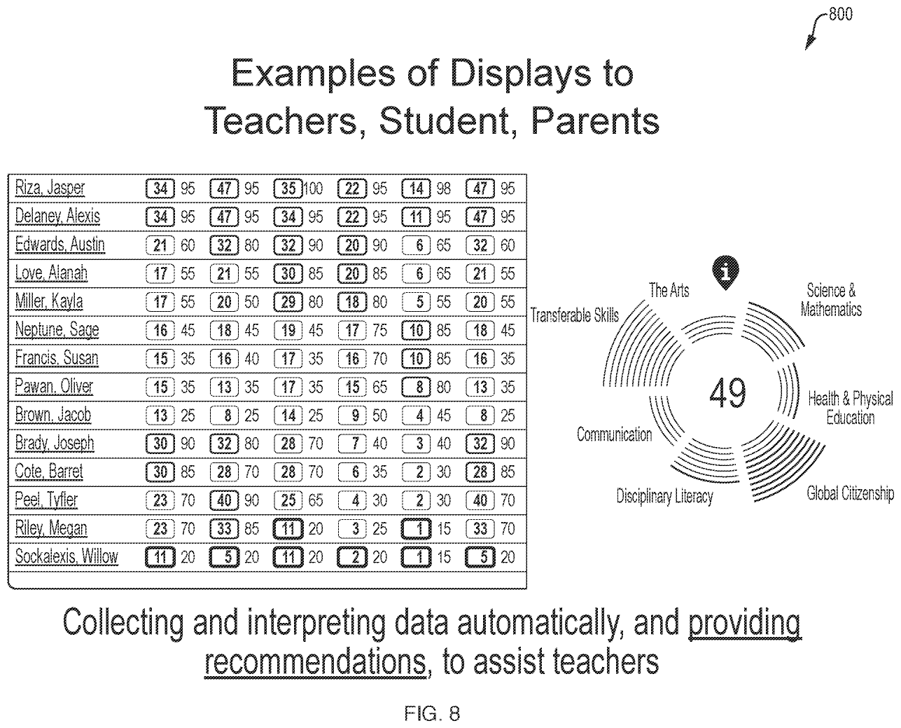

Embodiments of the present invention may generate and display a “report card” 800 for one or more students, as shown in FIG. 8. For example, the scores shown for each student may be relative to the student's previous scores: an indication of how much their collaboration skills have improved. Alternatively, the scores may be broken down by sub-competency, to help the teacher better understand what they need to teach. If their whole class is struggling with COL3, for example, this may indicate to an instructor that their class needs help learning how to manage interpersonal conflict.

Report cards, such as the one shown in FIG. 8, may be time-specific (e.g., for a particular day, week, month, semester, or year). Such time-specific report cards may provide any one or more of the following, each of which is an example of “guidance,” as that term is used herein:
feedback on past performance, and may include scores for each of a plurality of time periods (e.g., weeks/months);
real-time feedback on current performance, such as performing instantaneous or same-day feedback to a student; and/or
predictive (future) “feedback,” in order to help the student correct his or her traj ectory.

Different report cards may be generated for different audiences, such as parents, teachers, and students.

In addition to providing output representing the performance of students over time, embodiments of the present invention may automatically generate, and generate output representing, one or more recommendations (which are an example of “guidance,” as that term is used herein) for improving the performance of those students. For example, embodiments of the present invention may determine, based on the student data 1204 (which may include, for example, any of the assessments 1208a-n and 1212), that the performance of the student 1202 falls below a desired level, such as by determining that a proficiency level of the student is less than a desired value. In response to such a determination, embodiments of the present invention may automatically generate, and generate output representing, a recommendation for improving the performance of a student.

Such recommendations may be generated in any of a variety of ways. For example, for each of a plurality of types of performance deficiencies, embodiments of the present invention may store one or more corresponding recommendations. When an embodiment of the present invention determines that the performance of the student 1202 is deficient, the type of the student's performance deficiency may be identified, and one or more stored recommendations corresponding to the identified type of performance deficiency may be identified. Output representing the identified recommendation(s) may then be provided, e.g., to the student's teacher. Examples of types of performance deficiencies include proficiency level deficiencies, discipline deficiencies, competency deficiencies, and sub-competency deficiencies. For example, in response to determining that the student 1202's proficiency in mathematics has been deficient for at least some predetermined amount of time (such as by being below some predetermined value, or by being below a certain percentile in the student 1202's class or other cohort), embodiments of the present invention may identify one or more stored recommendations associated with deficiencies in mathematics, and generate output representing the identified recommendation(s).

A student's internal state (e.g., knowledge, beliefs, values, opinions, feelings, motivations, attitudes, and skills) may or may not be aligned with the student's external behavior. For example, a student's internal state and external behavior may be aligned when the student strongly values collaboration and engages in collaboration with other students. However, the student's internal state and external behavior may be misaligned with the student exhibits collaborative behavior but only does so to please the teacher. Conversely, the student may place a strong value on collaboration, but fail to act collaboratively due to lack of skill at collaborating or fear or social interaction.

Embodiments of the present invention may automatically determine whether the student 1202's internal state and external behavior are aligned with each other by analyzing the student output 1204 (which may include the assessments 1208a-n and/or the assessment 1212). In general, embodiments of the present invention may perform this determination by: (1) generating, based on the student output 1204, a representation of the student 1202's internal state; (2) generating, based on the student output 1204, a representation of the student 1202's external behavior; (3) identifying a difference between the representation of the student 1202's internal state and the student 1202's external behavior; and (4) determining whether the student 1202's internal state and external behavior are aligned based on the identified difference. For example, a metric may be calculated based on the difference, and the student 1202's internal state and external behavior may be determined to be misaligned if they differ by more than some predetermined threshold, and to be aligned if they differ by less than the predetermined threshold.

As a particular example, embodiments of the present invention may assign a proficiency level to the student 1202's internal state and may assign a proficiency level to the student 1202's external behavior, such as any of the proficiency levels disclosed herein. The student 1202's internal state and external behavior may be determined to be aligned if the proficiency level assigned to the student 1202's internal state is the same as the proficiency level assigned to the student 1202's external behavior; otherwise, the student 1202's internal state and external behavior may be determined to be misaligned.

As merely one example of techniques that may be used to assign such proficiency levels to the student 1202's internal state and external behavior in connection with a strategy or skill (competencies and sub-competencies are examples of skills), embodiments of the present invention may:
Assign a first proficiency level to the student 1202's internal state if the student 1202 is determined not to feel compelled or motivated to do or use the strategy or skill, and/or if the student 1202 does not understand the need or reason for the strategy or skill.
Assign the first proficiency level to the student 1202's external behavior if the student is able to do discrete or partial aspects of the strategy or skill, if the student 1202 uses sub-par strategies imperfectly, and/or if the student can only exhibit the strategy or skill in familiar and simple contexts.
Assign a second proficiency level to the student 1202's internal state if the student 1202 feels somewhat interested in and motivated to use the strategy or skill, and/or the student recognizes that the strategy or skill is helpful, but not necessarily when or why to use the strategy or skill.
Assign the second proficiency level to the student 1202's external behavior if the student 1202 has an ability to do more than one discrete aspect of the strategy or skill, can execute sub-par strategies, and/or can execute the strategy or skill in familiar and slightly more complex contexts.
Assign a third proficiency level to the student 1202's internal state if the student 1202 is interested in and motivated to do or use the strategy or skill, and/or the student 1202 understands some of the specific conditions or needs that the strategy or skill can accomplish.
Assign the third proficiency level to the student 1202's external behavior if the student 1202 has an ability to perform multiple, key aspects of the strategy or skill, uses best practices to varying degrees of success when executing the strategy or skill, and/or can perform the strategy or skill in similar, but more complex contexts.
Assign a fourth proficiency level to the student 1202's internal state if the student 1202 is very motivated, performs the strategy or skill subconsciously, and/or has a deep understanding of the reasons and conditions for the strategy or skill.
Assign the fourth proficiency level to the student 1202's external behavior if the student 1202 has the ability to modify and use aspects of the strategy or skill or combine it with other skills, uses best practices effectively, and/or can flexibly apply the strategy or skill in complex and novel contexts.

Any of the techniques disclosed herein as being performed in connection with a particular task, activity, project, or application, may be performed repeatedly over time for a plurality of signals, tasks, activities, projects, grade levels, weights, disciplines, competencies, social environments, student personalization, cultural adaptations, applications and the like, and the resulting data generated using the techniques disclosed herein may be stored and aggregated in any of a variety of ways to update the student's assessment over any time period and any range of signals, tasks, activities, projects, grade levels, weights, disciplines, competencies, social environments, student personalization, cultural adaptations, applications and the like.

One aspect of the present invention is directed to a method performed by at least one computer processor executing computer program instructions stored on at least one non-transitory computer-readable medium. The method includes: (A) receiving output representing a student; (B) applying a plurality of assessment methods to the student output to produce a plurality of corresponding individual assessments; and (C) processing the plurality of corresponding individual assessments to produce an integrated assessment for the student; (D) generating guidance based on the integrated assessment; and (E) providing output representing the guidance. Any data disclosed herein which is generated based on one or more assessments (e.g., any one or more of assessments 1208a-n and/or assessment 1212) is an example of “guidance,” as that term is used herein, whether or not the term “guidance” is used explicitly in connection with that data.

In operation (E), the output representing the guidance may be provided to any one or more of the following: the student, a teacher of the student, a parent of the student, a guardian of the student, and an administrator at a school of the student.

The output representing the guidance may include, for example, digital output received via at least one computing device (e.g., from the student).

Each of the plurality of assessment methods may assess the student relative to a corresponding competency, and the plurality of corresponding individual assessments may represent the student's abilities relative to the corresponding competency. Each of the plurality of corresponding individual assessments may consist of a numerical score of the student in relation to the corresponding competency. The integrated assessment may include a numerical score of the student in relation to the plurality of competencies, and (C) may include generating the numerical score of the student in relation to the plurality of competencies based on the plurality of corresponding individual assessments.

The plurality of competencies may include at least skill-related competencies, character-related competencies, and meta-learning-related competencies. The skill-related competencies may include at least one of creativity, critical thinking, communication, and collaboration The character-related competencies may include at least one of mindfulness, curiosity, courage, resilience, ethics, and leadership. The meta-learning-related competencies may include at least one of metacognition and growth mindset.

The student output may include input provided by the student to at least one computing device, and (B) may include, for each of a plurality of competencies C, for each of a plurality of sub-competencies Cs of competency C: (B)(1) identifying a set of digital activities which are indicators of sub-competency Cs; (B)(2) for each digital activity in the identified set, determining whether the student output includes output indicating that the student engaged in the activity; and (B)(3) producing an assessment for sub-competency Cs based on the determinations in (B)(2).

In the method, (A) may include receiving the output from the student during a first time period; the plurality of corresponding individual assessments may correspond to the first time period; and the integrated assessment may correspond to the first time period; and the method may further include repeating (A)-(C) for a second time period that is later than the first time period. The second time period may, for example, be at least one month later than the first time period or at least six months later than the first time period.

In the method, (B) may include: identifying an activity performed by the student; determining that the activity is an example of a particular task; identifying a competency and sub-competency associated with the particular task; identifying a progression level associated with the digital activity, competency, sub-competency, and task; and assigning the progression level to the student. The activity may include a digital activity performed by the student using at least one computing device.

In the method, (A) may include receiving physiological signals from at least one physiological sensor that generates the physiological signals based on physiological parameters of the student.

The method may further include: (D) repeating (A)-(C) for a plurality of students, thereby producing a plurality of integrated assessments for the plurality of students; and (E) identifying a pattern in the plurality of integrated assessments for the plurality of students. The method may further include: (F) determining whether additional data associated with the plurality of students exhibits the identified pattern. Identifying the pattern may include identifying, based on the plurality of integrated assessments for the plurality of students, a first competency that is a precursor for developing at least one second competency. Identifying the pattern may include: identifying, based on the plurality of integrated assessments for the plurality of students, an initial sub-competency that is a precursor for developing at least one subsequent sub-competency.

The method may further include: (D) generating a representation of the student's internal state based on the output from the student; (E) generating a representation of the student's external behavior based on the output from the student; (F) identifying a difference between the representation of the student's internal state and the representation of the student's external behavior; and (G) determining whether the student's internal state is aligned with the student's external behavior based on the difference. Identifying the difference may include: (F)(1) assigning a first proficiency level to the student's internal state; (F)(2) assigning a second proficiency level to the student's external behavior; (F)(3) determining whether the first proficiency level is the same as the second proficiency level; and determining whether the student's internal state is aligned with the student's external behavior may include: (G)(1) in response to determining that the first proficiency level is the same as the second proficiency level, determining that the student's internal state is aligned with the student's external behavior; and (G)(2) in response to determining that the first proficiency level is not the same as the second proficiency level, determining that the student's internal state is not aligned with the student's external behavior.

Another aspect of the present invention is directed to a system comprising at least one non-transitory computer-readable medium having computer program instructions stored thereon. The computer program instructions are executable by at least one computer processor to perform a method. The method includes: (A) receiving output representing a student; (B) applying a plurality of assessment methods to the student output to produce a plurality of corresponding individual assessments; and (C) processing the plurality of corresponding individual assessments to produce an integrated assessment for the student (D) generating guidance based on the integrated assessment; and (E) providing output representing the guidance.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

What is claimed is:

1. A method performed by at least one computer processor executing computer program instructions stored on at least one non-transitory computer-readable medium, the method comprising:
(A) receiving output representing a student;
(B) applying a plurality of assessment methods to the student output to produce a plurality of corresponding individual assessments; and
(C) processing the plurality of corresponding individual assessments to produce an integrated assessment for the student;
(D) generating guidance based on the integrated assessment; and
(E) providing output representing the guidance.

2. The method of claim 1, wherein (E) comprises providing the output representing the guidance to the student.

3. The method of claim 1, wherein (E) comprises providing the output representing the guidance to at least one of a teacher of the student, a parent of the student, a guardian of the student, and an administrator at a school of the student.

4. The method of claim 1, wherein:
the output includes digital output received via at least one computing device.

5. The method of claim 4, wherein the output includes digital output received from the student.

6. The method of claim 1, wherein each of the plurality of assessment methods assesses the student relative to a corresponding competency, and wherein the plurality of corresponding individual assessments represents the student's abilities relative to the corresponding competency.

7. The method of claim 6, wherein each of the plurality of corresponding individual assessments consists of a numerical score of the student in relation to the corresponding competency.

8. The method of claim 7, wherein the integrated assessment comprises a numerical score of the student in relation to the plurality of competencies, and wherein (C) comprises generating the numerical score of the student in relation to the plurality of competencies based on the plurality of corresponding individual assessments.

9. The method of claim 1, wherein the plurality of competencies includes at least skill-related competencies, character-related competencies, and meta-learning-related competencies.

10. The method of claim 9, wherein the skill-related competencies include at least one of creativity, critical thinking, communication, and collaboration

11. The method of claim 9, wherein the character-related competencies include at least one of mindfulness, curiosity, courage, resilience, ethics, and leadership.

12. The method of claim 9, wherein the meta-learning-related competencies include at least one of metacognition and growth mindset.

13. The method of claim 1:
wherein the student output includes input provided by the student to at least one computing device;
wherein (B) comprises, for each of a plurality of competencies C, for each of a plurality of sub-competencies Cs of competency C:
(B)(1) identifying a set of digital activities which are indicators of sub-competency Cs;
(B)(2) for each digital activity in the identified set, determining whether the student output includes output indicating that the student engaged in the activity; and
(B)(3) producing an assessment for sub-competency Cs based on the determinations in (B)(2).

14. The method of claim 1:
wherein (A) comprises receiving the output from the student during a first time period;
wherein the plurality of corresponding individual assessments corresponds to the first time period; and
wherein the integrated assessment corresponds to the first time period; and
wherein the method further comprises repeating (A)-(C) for a second time period that is later than the first time period.

15. The method of claim 14, wherein the second time period is at least one month later than the first time period.

16. The method of claim 14, wherein the second time period is at least six months later than the first time period.

17. The method of claim 1, wherein (B) comprises:
identifying an activity performed by the student;
determining that the activity is an example of a particular task;
identifying a competency and sub-competency associated with the particular task;
identifying a progression level associated with the digital activity, competency, sub-competency, and task; and
assigning the progression level to the student.

18. The method of claim 17, wherein the activity comprises a digital activity performed by the student using at least one computing device.

19. The method of claim 1, wherein (A) comprises receiving physiological signals from at least one physiological sensor that generates the physiological signals based on physiological parameters of the student.

20. The method of claim 1, further comprising:
(D) repeating (A)-(C) for a plurality of students, thereby producing a plurality of integrated assessments for the plurality of students; and
(E) identifying a pattern in the plurality of integrated assessments for the plurality of students.

21. The method of claim 20, further comprising:
(F) determining whether additional data associated with the plurality of students exhibits the identified pattern.

22. The method of claim 20, wherein (E) comprises:
identifying, based on the plurality of integrated assessments for the plurality of students, a first competency that is a precursor for developing at least one second competency.

23. The method of claim 20, wherein (E) comprises:
identifying, based on the plurality of integrated assessments for the plurality of students, an initial sub-competency that is a precursor for developing at least one subsequent sub-competency.

24. The method of claim 1, further comprising;
(D) generating a representation of the student's internal state based on the output from the student;
(E) generating a representation of the student's external behavior based on the output from the student;
(F) identifying a difference between the representation of the student's internal state and the representation of the student's external behavior; and
(G) determining whether the student's internal state is aligned with the student's external behavior based on the difference.

25. The method of claim 24:
wherein (F) comprises:
(F)(1) assigning a first proficiency level to the student's internal state;
(F)(2) assigning a second proficiency level to the student's external behavior;
(F)(3) determining whether the first proficiency level is the same as the second proficiency level; and
wherein (G) comprises:
(G)(1) in response to determining that the first proficiency level is the same as the second proficiency level, determining that the student's internal state is aligned with the student's external behavior; and
(G)(2) in response to determining that the first proficiency level is not the same as the second proficiency level, determining that the student's internal state is not aligned with the student's external behavior.

26. A system comprising at least one non-transitory computer-readable medium having computer program instructions stored thereon, the computer program instructions being executable by at least one computer processor to perform a method, the method comprising:
(A) receiving output representing a student;
(B) applying a plurality of assessment methods to the student output to produce a plurality of corresponding individual assessments; and
(C) processing the plurality of corresponding individual assessments to produce an integrated assessment for the student
(D) generating guidance based on the integrated assessment; and
(E) providing output representing the guidance.
